(19) United States
(12) Patent Application Publication
(10) Pub. No.: US 2020/0150586 A1
(43) Pub. Date: May 14, 2020

(54) HOLOGRAPHIC SECURITY DEVICE AND METHOD OF MANUFACTURE THEREOF

(71) Applicant: DE LA RUE INTERNATIONAL LIMITED, Basingstoke, Hampshire (GB)

(72) Inventors: Brian HOLMES, Fleet (GB); Frederic FOURNIER, Thatcham (GB); Maria del Pilar KING, Andover (GB)

(73) Assignee: DE LA RUE INTERNATIONAL LIMITED, Basingstoke, Hampshire (GB)

(21) Appl. No.: 16/616,925

(22) PCT Filed: May 25, 2018
(86) PCT No.: PCT/GB2018/051435

§ 371 Date: Nov. 25, 2019

(30) Foreign Application Priority Data
May 25, 2017 (GB) 1708387.4

(51) Int. Cl. G03H 1/00; G03H 1/02; G02B 27/06; G02B 30/27; B42D 25/328; B42D 25/29; B42D 25/342; B42D 25/355

(52) U.S. Cl. CPC G03H 1/0011; G03H 1/0244; G02B 27/06; B42D 25/355; B42D 25/328; B42D 25/29; B42D 25/342; G02B 30/27

(57) ABSTRACT

A holographic security device includes a holographic image layer which when illuminated exhibits the optically variable effect of viewing first and second overlapping patterns of elements, wherein; the first pattern of elements includes a first set of image elements and at least a second set of image elements, and the pitches and relative locations of the first and second patterns of elements are such that, upon illumination of the device; at a first viewing position of the security device the first set of image elements are exhibited by the holographic image layer and at a second, different viewing position of the security device the second set of image elements are exhibited by the holographic image layer. Also, an associated method of manufacture of the security device.

### FIELD OF THE INVENTION

The invention relates to a holographic security device, for example for use on documents of value such as banknotes, cheques, passports, identity cards, certificates of authenticity, fiscal stamps and other secure documents. Methods of manufacturing such a security device are also disclosed.

### BACKGROUND TO THE INVENTION

Articles of value, and particularly documents of value such as banknotes, cheques, passports, identity cards, certificates of authenticity, fiscal stamps and other secure documents, are frequently the target of counterfeiters and persons wishing to make fraudulent copies thereof and/or changes to any data therein. Typically such documents are provided with a number of visible security devices for checking the authenticity of the object. Holographic devices are widely used as such security devices and provide an optically variable effect to an observer, meaning that the appearance of the device is different at different angles of view. Holographic security devices are particularly effective since direct copies (e.g. photocopies) will not produce the optically variable effect and hence can be readily distinguished from genuine devices.

Conventional holograms comprise a surface relief where the diffraction of incident light from the surface relief generates the holographic effect. Typically the holographic effect is the projection of the image of a three-dimensional object with parallax, which provides a striking optically variable effect for a viewer that is easily authenticatable. However, with the increasing sophistication of counterfeiters, simple three-dimensional holograms are no longer as secure as they once were.

As a response to this, holographic security devices were provided as described in WO 93/24333, where the holographic effect exhibited a moiré pattern produced from a pair of overlapping, regular arrays of lines or dots having very similar form, and with each array having a line of symmetry. Furthermore the lines of symmetry of the two arrays were aligned. A viewer of such a device therefore observed a moiré pattern that remained substantially uniform in form on changing the viewing position (i.e. tilting the device). The precision required to ensure that the axes of symmetry were aligned in order to provide the substantially uniform holographic image was greater than that which could be provided by counterfeiters, and as such these devices had a high security level.

However, counterfeiting technology has inevitably improved, and there is therefore the need to provide holographic security devices having increased security.

### SUMMARY OF THE INVENTION

In accordance with a first aspect of the invention there is provided a holographic security device comprising a holographic image layer which when illuminated exhibits the optically variable effect of viewing first and second overlapping patterns of elements, wherein; the first pattern of elements comprises a first set of image elements and at least a second set of image elements, and the pitches and relative locations of the first and second patterns of elements are such that, upon illumination of the device; at a first viewing position of the security device the first set of image elements are exhibited by the holographic image layer and at a second, different viewing position of the security device the second set of image elements are exhibited by the holographic image layer.

The security device of the present invention is a holographic security device in that the effect exhibited to a viewer upon viewing the device is generated by the diffraction of light from the holographic image layer. The holographic image layer exhibits the optically variable effect of viewing first and second patterns of elements without the patterns of elements needing to be physically present in the device. This dramatically increases the ease with which the security device may be incorporated into a security document (such as a passport), as the document itself does not need to be modified in order to exhibit the effect. Furthermore, the difficulty of counterfeiting is increased as it is difficult for a would-be counterfeiter to re-create the holographic image layer.

Typically, the holographic image layer comprises a holographic recording of the optically variable effect of viewing the first and second overlapping patterns of elements. Preferably the optically variable effect exhibited by the holographic image layer is a variable image; the image being variable in that it is perceived to change dependent on viewing position of the device. The variable image seen when viewing the security device at varying viewing positions corresponds to the variable image that would be seen when viewing the first and second patterns of elements. In other words, the device replays a holographic reproduction (or “holographic image”) of the effect that would be observed when viewing physical first and second patterns of elements.

The first and second patterns of elements are typically arranged parallel to each other and are spaced apart in a direction perpendicular to the planes of the patterns. This means that, on tilting the security device to observe parallax effects due to the separation of the patterns, a viewer will observe, at a first viewing position, the first set of image elements which typically cooperate together to form a first recognisable image and observe, at a second viewing position, the second set of image elements which similarly typically cooperate together to form a second recognisable image. The first and second viewing positions may be referred to as different viewing angles of the device. Typically, at least one of the first and second patterns of elements, or both in combination, define indicia, preferably a letter, digit, geometric shape, symbol, image, graphic or alphanumerical text. It is envisaged that for the majority of applications, only the first pattern of elements (comprising the first and second sets of image elements) will define indicia. For example, the first set of image elements may define a star shape, and the second set of image elements may also define a star shape but of a smaller size. Tilting the device would then exhibit a dynamic effect of the star growing and shrinking in size. In such a situation, the first and second sets of image elements may be interleaved with each other, such that the star shapes appear in substantially the same spatial location at the first and second viewing positions, with the only dynamic effect being the apparent change in size.

The first set of image elements may define indicia at a first spatial location and the second set of image elements may define indicia at a second spatial location such that upon changing viewing positions (for example by tilting the device relative to the viewer) a viewer perceives animation of said indicia from the first to the second spatial locations.

This so-called “phase interference” effect provided by the first aspect of the invention provides a memorable effect to a viewer, and enhanced security of the device.

Typically, the viewing position of the device is changed by tilting the device, relative to an observer, about tilt axis substantially within the plane of the device. The different viewing positions are typically different viewing angles of the device. It will be appreciated that substantially the same effect may be observed by an observer moving with the device remaining stationary.

For example, the first and second viewing positions may be positioned along a first axis, wherein the first and second patterns of elements are arranged such that the first and second sets of image elements are exhibited to a viewer when the device is tilted along a tilt axis not parallel to the first axis. Typically, the first axis and the tilt axis are substantially perpendicular, with the tilt axis preferably lying substantially in the plane of the security device.

Preferably, the first pattern of elements further comprises a third set of image elements that are exhibited at a third viewing position of the security device.

Similarly to above, the third set of image elements will together preferably define a third recognisable image, enabling more complex dynamic effects (such as animation) to be exhibited to a viewer when tilting the device. Further preferred embodiments may include fourth and further sets of image elements.

The first and second patterns of elements are provided in an overlapping manner, and may be fully overlapping or partially overlapping. Importantly, there must be at least partial overlap of the patterns of elements such that an interference effect generated by the two patterns can be recorded in the holographic image layer. The first pattern of elements can be thought of as an “information” or “artwork” pattern, and the second pattern of elements as a “decoding” or “sampling” pattern. Typically, when recording the holographic image layer, an object beam is directed firstly through the artwork pattern and subsequently the sampling pattern, with the resulting interference effect being recorded in the holographic image layer.

In one embodiment, the sampling pattern of elements comprises a periodic or quasi-periodic array of substantially opaque and substantially transparent regions, typically arranged as a one dimensional line screen pattern or dot screen pattern. The term “transparent” means that light is transmitted through the transparent regions of the sampling pattern with low optical scattering such that the image elements of the artwork pattern can be viewed through the sampling pattern with minimal obscuration. Conversely, the term “opaque” means that light does not pass through the opaque regions such that the image elements of the artwork pattern cannot be viewed through the opaque regions. Therefore, the second (“sampling”) pattern of elements controls which parts of the first (“artwork”) pattern are visible at certain viewing angles when tilting the device. Furthermore, the size ratio between the opaque and transparent regions of the sampling pattern controls the number of frames at which the artwork pattern replays (and therefore the number of discrete frames exhibited when viewing the final device). For example, the sampling pattern may comprise a one-dimensional line screen comprising 600 μm wide substantially opaque rectangular regions separated by 100 μm wide substantially transparent regions, which would provide seven frames exhibited at seven corresponding viewing angles. The artwork pattern of elements would then preferably comprise seven sets of interleaved (or “interlaced”) image elements, with each image set displaced by 100 μm along the viewing direction from adjacent interlaced image sets and intended to be viewable through the transparent regions of the sampling plate at different viewing angles.

In general, for N image channels, the first pattern of elements will be comprised of N interlaced strip patterns of width RD/N (where RD is the repeat distance (or pitch) of the second pattern of elements). In the above example, this is 100 μm. Thus each interlaced strip of the first pattern of elements matches a transparent region of the second pattern of elements and the holographic security device behaves like a low brightness N channel lenticular device.

The width of the substantially transparent regions of the second pattern of elements may be increased to advantageously increase transmissive brightness of the device and/or reduce the visibility of the second pattern of elements in the final replayed image when viewing the device, but this will be at the cost of greater image overlap.

In some preferred embodiments, the second pattern of elements comprises a one dimensional or two dimensional array of focussing elements, which advantageously increases the brightness of the final replayed image. This will be explained in more detail below.

In accordance with a second aspect of the present invention there is provided a holographic security device comprising a holographic image layer which when illuminated exhibits the optically variable effect of viewing first and second overlapping patterns of elements, wherein; the pitches and/or relative rotations of the first and second patterns of elements and their relative locations are such that, upon illumination of the device; the holographic image layer exhibits a magnified version of at least a part of the first pattern of elements due to the moiré effect, and further wherein; at least one of the first and second patterns of elements comprises a first area having a first pitch along at least one axis and a second area having a second, different pitch along said axis, whereby the moiré effect causes different degrees of magnification of the first pattern of elements to occur, such that the holographic image layer exhibits areas of different depth corresponding to the first and second areas.

This aspect of the invention advantageously uses the effect of moiré magnification to provide a holographic image layer that exhibits different perceived depths in order to provide a memorable, easily authenticatable image to a viewer of the security device. This is particularly beneficial as the different depth effects can be exhibited using first and second patterns of elements that are positioned substantially parallel to each other (for example the patterns of elements may typically be provided on transparencies or substantially transparent plates, e.g. a flat emulsion coated glass) rather than generating different depth effects by non-parallel positioning of the patterns of elements.

The moiré magnification factor depends upon the difference between the periodicities or pitches of the first and second patterns of elements. (As with the first aspect of the invention the first pattern of elements can be thought of as the “artwork” pattern and the second pattern of elements thought of as the “sampling” pattern.) A pitch mismatch between the two patterns of elements along an axis can also conveniently be generated by rotating one pattern relative to the other, such that the two patterns have a rotational misalignment.

Preferably, as in the first aspect, the first or second patterns of elements, or both in combination, define indicia, preferably a letter, digit, geometric shape, symbol, image, graphic or alphanumerical text.

Typically, the first pattern of elements comprises an array of image elements that are compressed along at least the axis along which magnification occurs due to the moiré effect. The compression factor of the image elements is determined such that the magnified image elements exhibited upon viewing the holographic image layer of the device have the desired aspect ratio. As it is the relative pitch mismatch (or rotational misalignment) between the two patterns of elements that gives rise to the moiré magnification, the array of image elements may have a constant pitch along an axis with the second pattern of elements comprising regions of different pitch along the same axis in order to provide apparent magnification. Alternatively or in addition, the array of image elements may have varying pitch along an axis, with the second pattern of elements having a constant pitch. This second scenario is generally preferred as it allows the same second (“sampling”) pattern to be used for a variety of different artwork patterns, which beneficially allows for efficient personalisation of the security devices. The apparent depth difference between objects within the final hologram image is a particularly striking effect.

At least one image element may comprise at least two sub-elements configured to have different degrees of magnification such that a viewer such that a viewer of the device perceives the image element to have a three dimensional appearance.

In the case where the first pattern of elements comprises an array of image elements, tilting of the device exhibits apparent fast movement of the image elements along an axis not parallel with a tilting axis, due to progressive sampling across individual image elements. Typically the axis along which the image elements appear to move is substantially perpendicular to the tilt axis.

This fast movement of image elements in the exhibited holographic image upon tilting of the device provides a distinctive effect to a viewer, especially in combination with the perceived depth of the image elements.

The pitch of the array of image elements may vary continuously along at least one axis of at least one region, whereby the moiré effect causes different degrees of magnification of the image elements to occur, such that the viewer perceives that the magnified image elements are located on a first image surface that is tilted or curved with respect to the surface of the security device. This provides a device where the holographic image viewed by an observer has an image plane or surface that is appears noticeably tilted or curved relative to the plane of the device. This visual effect significantly enhances the visual appearance of the security device and, moreover, enhances the security level associated with the device since the necessary pitch requirements of the first and second patterns of elements increases the complexity of manufacture and deters would-be counterfeiters.

The pitch of the array of image elements may vary in a linear (constant gradient) or non-linear (variable gradient) manner.

It should be noted that, due to the potential for the holographic images exhibited by the device to appear curved, the term “image surface” will generally be used in place of “image plane”. However, in places where the latter term is used, it will be appreciated that the term “plane” is not limited to being flat unless otherwise specified.

The term “continuously varies” in this context means that the pitch variation across the array of image elements is such that the resulting image surface on which the magnified image elements are perceived in the variable holographic image appears smooth to the human eye.

The image elements in the array can all be identical in size, in which case the varying magnification levels across the device will cause size distortion. This can be used as a visual effect in itself. However, in preferred embodiments, the size of the image elements varies in a corresponding manner such that the viewer perceives that the magnified image elements have substantially the same size as each other on the first image surface.

Alternatively or in addition to the array of image elements continuously varying in pitch, the pitch of the second pattern of elements may vary continuously along at least one axis of at least one region. In the same manner as above, this causes different degrees of magnification of the image elements to occur, such that the viewer perceives that the magnified image elements are located on a first image surface that is tilted or curved with respect to the surface of the security device. It is envisaged that typically the magnification effects will be generated by varying the pitch of the first pattern of elements (the “artwork” array) while using a second pattern of elements having a constant pitch, as this allows for ease of personalisation of the security devices simply by changing the first pattern of elements as appropriate.

In some embodiments the pitches of the first and second patterns of elements and their relative locations are such that a first image surface is positioned in front of or behind the surface of the security device. In other advantageous implementations, the pitches of the first and second patterns of elements and their relative locations are such that a first image surface intersects the surface of the security device.

In particularly advantageous embodiments of the present invention, the first pattern of elements comprises a first set of image elements and at least a second set of image elements, and; the pitches and relative locations of the first and second patterns of elements are such that at a first viewing position of the device the first set of image elements are exhibited by the holographic image layer and at a second, different viewing position of the device the holographic image layer exhibits the second set of image elements. A combination of the phase interference effects described above in the first aspect of the invention together with the moiré magnifier effects described in the second aspect provides complex holographic images that are exhibited to an observer of the device. This complexity of the holographic security device significantly increases its security level as would-be counterfeiters are deterred by the difficulty in reproducing such a holographic image layer.

The invention is primarily intended for use with white light viewable holographic image layers (“holograms”). Here white light comprises the visible part of the electromagnetic spectrum, i.e. between approximately 390 nm and 700 nm. Embossed holograms are one class of white light viewable holograms.

Embossed holograms are formed by surface relief patterns which diffract light in order to create the holographic effect. Such surface relief patterns may be replicated into polymeric layers in order to mass produce the article, using a master plate which exhibits the (inverse) surface relief pattern. Replication can be done by plastic deformation of a plastic film under heating, or by curing a polymeric composition under the influence of UV light or an electron beam while the composition is in intimate contact with a master plate. The holographic image layer of the security device may be principally reflective in its viewing such as being formed as a surface relief pattern (embossed hologram) in a transparent plastic film, which patterned surface is selectively metallised for example with a substantially opaque layer of aluminium. Alternatively, the holographic image layer may be partly reflective and partly transparent such as when the above transparent film would be coated with a thin layer of a material having a higher refractive index than the plastic such as zinc sulphide or titanium dioxide: such transparent holographic layers can be used as overlays for passport photographs and the like.

The inventors have discovered that the security device of the present invention advantageously provides additional security characteristics dependent upon the nature of the light used to illuminate the device (and therefore the holographic image layer). When illuminated with diffuse white light, there is a tendency towards a reduction in the chromatic saturation (i.e. loss of colour) of the final replayed image and/or a mixing or overlap of frames and parallax views. However, under spotlight or point source (for example a torch), only certain frames replay at a particular viewing angle, meaning that the holographic effect (such as apparent animation or different depths) appears clearly the viewer.

This phenomenon advantageously provides a “two-level” security characteristic of the security device, as the device will appear different under different lighting conditions (i.e. diffuse or spotlight). Indeed, the security device may be manufactured to deliberately replay an unrecognisable image when illuminated by anything other than a point source of light, and only replay the desired holographic effect under spotlight or a point light source.

In both the first and second aspects, the second pattern of elements may take a variety of forms. For example, it may comprise a one dimensional line screen pattern or dot screen pattern, and this is particularly suitable for the case where the holographic image layer comprises an embossed rainbow hologram created using a Benton slit and a H1/H2 recording process as is known in the art. Such a hologram exhibits parallax in a direction parallel with the length of the Benton slit and a colour rainbow variation in a direction orthogonal to the slit direction. In the present invention, the one dimensional sampling pattern will preferably be aligned along a direction orthogonal to the slit direction so that the different image elements are visible at different viewing positions when tilting the device, with the tilt axis typically being aligned perpendicular to the length of the Benton slit.

Alternatively, the sampling pattern may comprise a two dimensional line screen pattern or dot screen pattern. In such a scenario, the artwork pattern may also comprise a two dimensional pattern, and the security device will exhibit parallax effects to a viewer when tilted about two different tilt axes (typically perpendicular to each other). In addition to embossed holograms described above, volume (or “Lippmann”) holograms are another class of white light viewable holograms that may be used in the present invention. With a volume hologram, the hologram image is generated by Bragg reflection off a series of refractive index modulated planes within the volume of the material. Volume holograms are both wavelength and angularly selective with regard to the incident light and so do not show mixing of parallax views in the holographic image to the same degree as with embossed holograms. Although volume holograms may be used for one-dimensional embodiments, they are particularly suitable for use where the sampling pattern comprises a two dimensional pattern due to their wavelength and angle selectivity.

In the examples above, we have discussed the case where the second pattern of elements comprises a line screen (for example an array of horizontal and/or vertical lines) and/or dot screen pattern. More generally however, more complex effects can be generated using curved lines—for example the second pattern of elements may comprise a series of substantially opaque concentric circles separated by substantially transparent regions. In some embodiments, at least one of the first and second patterns of elements comprises a one dimensional line screen pattern or a one dimensional pattern of indicia. In other embodiments, at least one of the first and second patterns of elements comprises a two dimensional line screen pattern or dot screen pattern, or a two dimensional pattern of indicia.

Here, “one dimensional” is used to describe device that exhibit an optically variable effect on tilting about one axis, whereas “two dimensional” means that the device exhibits an optically variable effect on tilting about more than one axis.

In alternative embodiments of both the first and second aspects of the invention, the second pattern of elements may comprise a one dimensional or two dimensional array of focussing elements, typically microlenses. Where the second (“sampling”) pattern of elements comprises a line array or a dot array as described above, these lines or dots may be visible in the holographic image replayed by the security device, which may detract from the overall visual impression exhibited to a viewer (although it could be used as a visual effect in its own right). The use of an array of focussing elements advantageously means that the final variable holographic image does not contain any apparent lines originating from the second pattern of elements, whilst still maintaining striking visual effects on tilting. For example, the use of an array of (typically cylindrical) microlenses allows for replay of the different image arrays of the first pattern of elements at different viewing angles. Furthermore, moiré magnification can be exhibited by making use of an array of focussing elements (such as lenses or micromirrors) as the second pattern or elements and a corresponding array of microimage elements as the first pattern of elements. Each microimage element is a complete, miniature version of the image which is ultimately observed on viewing the device, and the array of focussing elements acts to select and magnify a small portion of each underlying microimage element, which portions are combined by the human eye such that the whole, magnified image is visualised. The magnified array appears to move relative to the device upon tilting and can be configured to appear above or below the surface of the device.

Advantageously, as the focussing elements are substantially transparent to light, the use of an array of focussing elements as the second pattern of elements increases the overall transmission efficiency of light through the patterns of elements as compared to an array of substantially opaque elements. Indeed, the use of an array of focussing elements may provide an increase in optical brightness of in excess of 50% over an array of substantially opaque elements.

In the case where an array of lenses is used as the second (“sampling”) pattern of elements, the first and second patterns of elements are typically separated by a distance substantially equal to the focal length of the lenses.

Volume holograms are particularly suited to embodiments where an array of focussing elements is used as the second pattern of elements.

In accordance with a third aspect of the invention, there is provided a holographic security device comprising a holographic image layer which when illuminated exhibits the optically variable effect of viewing first and second overlapping patterns of elements, wherein; the pitches and/or relative rotations of the first and second patterns of elements and their relative locations are such that, upon illumination of the device; the holographic image layer exhibits a magnified version of at least a part of the first pattern of elements due to the moiré effect, and further wherein; the holographic image layer comprises a volume hologram.

In accordance with a fourth aspect of the present invention, there is provided a security article comprising a security device according to any of the preceding aspects, wherein the security article is preferably a security thread, strip, patch, label or transfer foil.

In accordance with a fifth aspect of the present invention, there is provided a security document comprising an article according to the fourth aspect, wherein the security article is preferably located in a transparent window region of the document, or is inserted as a window thread, or is affixed to a surface of the document. The security document may be a passport, banknote, security label, identification card, driving licence or other document of value.

In accordance with a sixth aspect of the invention, there is provided a method of manufacturing a holographic image layer for a security device, comprising: providing a holographic recording medium; providing first and second overlapping patterns of elements, and; holographically recording, in the holographic recording medium, the optically variable effect generated by illuminating the first and second overlapping patterns of elements, wherein; the first pattern of elements comprises a first set of image elements and at least a second set of image elements, and; the pitches and relative locations of the first and second patterns of elements are such that, upon illumination of the holographic image layer, at a first viewing position of the holographic image layer the first set of image elements are exhibited and at a second, different viewing position of the holographic image layer the second set of image elements are exhibited.

It is envisaged that the recording of the optically variable effect (typically a variable image) in the recording medium may be done as is conventionally known in the art. For example, the holographic image layer may be formed through a conventional H1/H2 recording process, wherein the object image is recorded into an intermediate transmission hologram known as the H1 and then the image from the H1 is holographically projected onto or near the surface of second hologram known as the H2, here forming the holographic image layer. For the case of an embossed hologram the H2 would typically be comprised of a substrate coated in photo-resist. Following chemical processing of the H2 resist it would coated with a thin sub-100 nm layer of conductive metal such as Silver and then Nickel replicas from using electroplating. The holographic image layer is primarily intended to be viewed in white light, in which case the holographic image within the H1 may be confined to a Benton slit which in projection onto the H2 hologram sacrifices vertical parallax to form a rainbow hologram.

Alternatively, the hologram may comprise a volume hologram recorded as is known in the art, either via projection from an intermediate H1, wherein the reference beam impinges on the opposite side of the H2 to the H1 object beam, or by directly recording the object image into the volume master hologram. The recording of the holographic image layer may be performed using on-axis or off-axis geometry, and the holographic image layer may be intended to be viewed in transmission or reflection.

By the recording of the optically variable effect here, we mean that the interference effect generated by directing light through the overlapping patterns of elements is recorded in the holographic image layer such that, when the holographic image layer is illuminated, it replays the same variation with viewing angle that would be experienced by viewing the patterns of elements directly.

In the case of an embossed hologram, the holographic image layer is formed by surface relief patterns which diffract light in order to create the holographic effect and generate the resultant variable optical effect. Such surface relief patterns may be replicated into polymeric layers in order to mass produce the article, using a master plate which exhibits the (inverse) surface relief pattern. Replication can be done by plastic deformation of a plastic film under heating, or by curing a polymeric composition under the influence of UV light or an electron beam while the composition is in intimate contact with a master plate.

The first (“artwork”) pattern of elements comprises first and second sets of image elements. By using a corresponding second (“sampling”) pattern of elements, a distinctive “switching” effect can be exhibited by the holographic image layer, wherein at the first viewing position the first set of image elements combine to form a recognisable shape or image and at the second viewing position the second set of image elements combine to form a different recognisable shape or image. The contrast between the two sets of image elements provides a distinctive effect to a user. In some preferred embodiments, the first pattern of elements comprises a third set of image elements that that are exhibited at a third viewing position of the holographic image layer. This advantageously allows for more complex variable images to be exhibited, such as perceived animation if the sets of image elements are at different spatial locations.

Preferably, at least one of the first and second patterns of elements, or both in combination, define indicia, preferably a letter, digit, geometric shape, symbol, image, graphic or alphanumerical text.

This so-called “phase interference” effect provided by the sixth aspect of the invention provides a memorable effect to a user, and enhanced security.

In accordance with a seventh aspect of the invention, there is provided a method of manufacturing a holographic image layer for a security device, comprising: providing a holographic recording medium; providing first and second overlapping patterns of elements, and; holographically recording, in the holographic recording medium, the optically variable effect generated by illuminating the first and second overlapping patterns of elements, wherein; the pitches and/or relative rotations of the first and second patterns of elements and their relative locations are such that, upon illumination of the holographic image layer, the holographic image layer exhibits a magnified version of at least a part of the first pattern of elements due to the moiré effect, and further wherein; at least one of the first and second patterns of elements comprises a first area having a first pitch along at least one axis and a second area having a second, different pitch along said axis, whereby the moiré effect causes different degrees of magnification of the first pattern of elements to occur, such that the holographic image layer exhibits areas of different depth corresponding to the first and second areas.

As with the sixth aspect, it is envisaged that the recording of the resultant variable image in the recording medium may be performed as is conventionally known in the art. For example, the holographic image layer may be formed through a conventional H1/H2 recording process as is known in the art, wherein the object image is recorded into an intermediate transmission hologram known as the H1 and then the image from the H1 is holographically projected onto or near the surface of second hologram known as the H2. For the case of an embossed hologram the H2 would typically be comprised of a substrate coated in photo-resist. Following chemical processing of the H2 resist it would be coated with a thin sub-100 nm layer of conductive metal such as Silver and then Nickel replicas from using electroplating. The holographic image layer is primarily intended to be viewed in white light, in which case the holographic image within the H1 may be confined to a Benton slit which in projection onto the H2 hologram sacrifices vertical parallax to form a rainbow hologram.

Alternatively, the hologram may comprise a volume hologram recorded as is known in the art, either via projection from an intermediate H1, wherein the reference beam impinges on the opposite side of the H2 to the H1 object beam, or by directly recording the object image into the volume master hologram The recording of the holographic image layer may be performed using on-axis or off-axis geometry, and the holographic image layer may be intended to be viewed in transmission or reflection.

As has been described above, by the recording of the optically variable effect, we mean that the interference effect generated by directing light through the overlapping patterns of elements is recorded in the holographic image layer such that, when the holographic image layer is illuminated, it replays the same variation with viewing angle that would be experienced by viewing the patterns of elements directly.

In the case of an embossed hologram, the holographic image layer is formed by surface relief patterns which diffract light in order to create the holographic effect and generate the resultant variable optical effect. Such surface relief patterns may be replicated into polymeric layers in order to mass produce the article, using a master plate which exhibits the (inverse) surface relief pattern. Replication can be done by plastic deformation of a plastic film under heating, or by curing a polymeric composition under the influence of UV light or an electron beam while the composition is in intimate contact with a master plate.

This aspect of the invention advantageously uses the effect of moiré magnification to manufacture a holographic image layer that, when illuminated, exhibits different perceived depths in order to provide a memorable, easily authenticatable image to a viewer of the holographic image layer. This is particularly beneficial as the different depth effects can be exhibited using first and second patterns of elements that are positioned substantially parallel to each other (for example the patterns of elements may typically be provided on transparencies or substantially transparent plates that are positioned in a parallel manner) rather than generating different depth effects by the non-parallel positioning of the patterns of elements.

Similarly to the aspects above, the first or second patterns of elements, or both in combination, preferably define indicia, preferably a letter, digit, geometric shape, symbol, image, graphic or alphanumerical text.

Typically, the first pattern of elements comprises an array of image elements that are compressed along at least the axis along which magnification occurs due to the moiré effect. The compression factor of the image elements is determined such that the magnified image elements exhibited by the holographic image layer have the desired aspect ratio. As it is the relative pitch mismatch (or rotational misalignment) between the two patterns of elements that gives rise to the moiré magnification, the array of image elements may have a constant pitch along an axis with the second pattern of elements comprising regions of different pitch along the same axis in order to provide apparent magnification. Alternatively or in addition, the array of image elements may have varying pitch along an axis, with the second pattern of elements having a constant pitch. This second scenario is generally preferred as it allows the same second (“sampling”) pattern to be used for a variety of different artwork patterns, which beneficially allows for efficient personalisation of the holographic image layer.

At least one image element may comprise at least two sub-elements configured to have different degrees of magnification such that a viewer of the holographic image layer perceives the image element in the resulting variable image to have a three dimensional appearance.

In the case where the first pattern of elements comprises an array of image elements, tilting of the holographic image layer relative to a viewer (i.e. changing viewing position) exhibits apparent fast movement of the image elements along an axis not parallel with a tilting axis, due to different image elements being visible through the second pattern of elements at different viewing angles, with this effect having been recording in the holographic image layer. Typically the axis along which the image elements appear to move is substantially perpendicular to the tilt axis. This fast movement of image elements upon tilting of the device provides a distinctive effect to a viewer, especially in combination with the perceived depth of the image elements.

The pitch of the array of image elements may vary continuously along at least one axis of at least one region, whereby the moiré effect causes different degrees of magnification of the image elements to occur, such that the viewer perceives that the magnified image elements are located on a first image surface that is tilted or curved with respect to the surface of the holographic image layer. This provides a holographic image layer where the variable holographic image viewed by an observer has an image plane or surface that is appears noticeably tilted or curved relative to the plane of the holographic image layer. This visual effect significantly enhances the visual appearance of the holographic image layer and, moreover, enhances the security level associated with the holographic image layer since the necessary pitch requirements of the first and second patterns of elements increases the complexity of manufacture and deters would-be counterfeiters.

It should be noted that, due to the potential for the variable images generated by the holographic image layer to appear curved, the term “image surface” will generally be used in place of “image plane”. However, in places where the latter term is used, it will be appreciated that the term “plane” is not limited to being flat unless otherwise specified.

The term “continuously varies” in this context means that the pitch variation across the array of image elements is such that the resulting image surface on which the magnified image elements are perceived in the variable holographic image appears smooth to the human eye.

The image elements in the array can all be identical in size, in which case the varying magnification levels across the device will cause size distortion. This can be used as a visual effect in itself. However, in preferred embodiments, the size of the image elements varies in a corresponding manner such that the viewer perceives that the magnified image elements have substantially the same size as each other on the first image surface.

Alternatively or in addition to the array of image elements continuously varying in pitch, the pitch of the second pattern of elements may continuously along at least one axis of at least one region. In the same manner as above, this causes different degrees of magnification of the image elements to occur, such that the viewer perceives that the magnified image elements exhibited when viewing the holographic image layer are located on a first image surface that is tilted or curved with respect to the surface of the holographic image layer. It is envisaged that typically the magnification effects will be generated by varying the pitch of the first pattern of elements (the “artwork” array) while using a second pattern of elements having a constant pitch, as this allows for ease of personalisation of the holographic image layer simply by changing the first pattern of elements as appropriate.

In some embodiments the pitches of the first and second patterns of elements and their relative locations are such that a first image surface is positioned in front of or behind the surface of the holographic image layer. In other advantageous implementations, the pitches of the first and second patterns of elements and their relative locations are such that a first image surface intersects the surface of the holographic image layer.

In particularly advantageous embodiments of the method, the first pattern of elements comprises a first set of image elements and at least a second set of image elements, and; the pitches and relative locations of the first and second patterns of elements are such that at a first viewing position of the holographic image layer, the first set of image elements are exhibited by the holographic image layer and at a second, different viewing position of the holographic image layer, the second set of image elements are exhibited by the holographic image layer. A combination of the phase interference effects together with the moiré magnifier effects provides complex holographic images that are exhibited to an observer of the holographic image layer. This complexity of the holographic image layer significantly increases its security level as would-be counterfeiters are deterred by the difficulty in reproducing such a holographic image layer.

In both the sixth and seventh aspects, the second pattern of elements may take a variety of forms. For example, it may comprise a one dimensional line screen pattern or dot screen pattern, and this is particularly suitable for the case where the holographic image layer comprises an embossed rainbow hologram created using a Benton slit and a H1/H2 recording process as is known in the art. Such a hologram exhibits parallax in a direction parallel with the length of the Benton slit and a colour rainbow variation in a direction orthogonal to the slit direction. In the present invention, the one dimensional sampling pattern will preferably be aligned along a direction orthogonal to the slit direction so that the different image elements are visible at different viewing positions when tilting the device, with the tilt axis typically being aligned perpendicular to the length of the Benton slit (i.e. parallel with the direction of alignment of the sampling pattern).

Alternatively, the sampling pattern may comprise a two dimensional line screen pattern or dot screen pattern. In such a scenario, the artwork pattern may also comprise a two dimensional pattern, and the holographic image layer will exhibit parallax effects to a viewer when tilted about two different tilt axes (typically perpendicular to each other). Such an embodiment is particularly suitable for use where the holographic image layer comprises a volume (or “Lippmann”) hologram.

In the examples above, we have discussed the case where the second pattern of elements comprises a line screen (for example an array of horizontal and/or vertical lines) and/or dot screen pattern. More generally however, more complex effects can be generated using curved lines—for example the second pattern of elements may comprise a series of substantially opaque concentric circles separated by substantially transparent regions. In some embodiments, at least one of the first and second patterns of elements comprises a one dimensional line screen pattern or a one dimensional pattern of indicia. In other embodiments, at least one of the first and second patterns of elements comprises a two dimensional line screen pattern or dot screen pattern, or a two dimensional pattern of indicia.

In alternative embodiments of both the sixth and seventh aspects of the invention, the second pattern of elements may comprise a one dimensional or two dimensional array of focussing elements, typically microlenses. Where the second (“sampling”) pattern of elements comprises a line array or a dot array as described above, these lines or dots may be visible in the final holographic image, which may detract from the overall visual impression exhibited to a viewer (although it could be used as a visual effect in its own right). The use of an array of focussing elements advantageously means that the holographic image replayed by the holographic image layer does not contain any apparent lines from the second pattern of elements, whilst still maintaining striking visual effects on tilting of the holographic image layer. For example, the use of an array of (typically cylindrical) microlenses allows for replay of the different image arrays of the first pattern of elements at different viewing positions. Furthermore, moiré magnification can be exhibited by making use of an array of focussing elements (such as lenses or mirrors) as the second pattern or elements and a corresponding array of microimage elements as the first pattern of elements.

Each microimage element is a complete, miniature version of the image which is ultimately observed on viewing the device, and the array of focussing elements acts to select and magnify a small portion of each underlying microimage element, which portions are combined by the human eye such that the whole, magnified image is visualised. The magnified array appears to move relative to the holographic image layer upon tilting and can be configured to appear above or below the surface of the holographic image layer.

Advantageously, as the focussing elements are substantially transparent to light, the use of an array of focussing elements as the second pattern of elements increases the overall transmission efficiency of light through the patterns of elements as compared to an array of substantially opaque elements. Indeed, the use of an array of focussing elements may provide an increase in optical brightness of in excess of 50% over an array of substantially opaque elements.

In the case where an array of focussing elements is used as the second (“sampling”) pattern of elements, the first and second patterns of elements are typically separated by a distance substantially equal to the focal length of the lenses.

Volume holograms are particularly suited to embodiments where an array of focussing elements is used as the second pattern of elements.

In accordance with an eighth aspect of the invention there is provided a method of manufacturing a holographic image layer for a security device, comprising: providing a holographic recording medium; providing first and second overlapping patterns of elements, and; holographically recording, in the holographic recording medium, the optically variable effect generated by illuminating the first and second overlapping patterns of elements, wherein; the pitches and/or relative rotations of the first and second patterns of elements and their relative locations are such that, upon illumination of the holographic image layer, the holographic image layer exhibits a magnified version of at least a part of the first pattern of elements due to the moiré effect, and further wherein; the holographic image layer comprises a volume hologram.

The holographic image layer produced by the sixth to eighth aspect of the invention, is typically used to form a security device, wherein such a security device comprises the holographic image layer.

In accordance with a further aspect of the invention there is provided a holographic security device comprising a holographic image layer which, when illuminated, generates a variable image produced by first and second overlapping patterns of elements, wherein; the first pattern of elements comprises a first set of image elements and at least a second set of image elements, and; the pitches and relative locations of the first and second patterns of elements are such that the first and second patterns of elements cooperate to exhibit the first set of image elements at a first viewing position and to exhibit the second set of image elements at a second, different viewing position.

In accordance with a yet further aspect of the invention there is provided a holographic security device comprising a holographic image layer which, when illuminated, generates a variable image produced by first and second overlapping patterns of elements, wherein; the pitches and/or relative rotations of the first and second patterns of elements and their relative locations are such that the first pattern of elements cooperates with the second pattern of elements to generate a magnified version of at least a part of the first pattern of elements due to the moiré effect, and further wherein; at least one of the first and second patterns of elements comprises a first area having a first pitch along at least one axis and a second area having a second, different pitch along said axis, whereby the moiré effect causes different degrees of magnification of the first pattern of elements to occur, such that a viewer of the variable image perceives areas of different depth corresponding to the first and second areas.

In accordance with a yet further aspect of the invention there is provided a holographic security device comprising a holographic image layer which, when illuminated, generates a variable image produced by first and second overlapping patterns of elements, wherein; the pitches and/or relative rotations of the first and second patterns of elements and their relative locations are such that the first pattern of elements cooperates with the second pattern of elements to generate a magnified version of at least a part of the first pattern of elements due to the moiré effect, and further wherein; the holographic image layer comprises a volume hologram.

In accordance with a yet further aspect of the invention there is provided a method of manufacturing a holographic image layer for a security device, comprising: providing a holographic recording medium; providing first and second overlapping patterns of elements, and; holographically recording, in the holographic recording medium, the resultant variable image generated by illuminating the first and second overlapping patterns of elements, wherein; the first pattern of elements comprises a first set of image elements and at least a second set of image elements, and; the pitches and relative locations of the first and second patterns of elements are such that the first and second patterns of elements cooperate to exhibit the first set of image elements at a first viewing position of the resultant image and to exhibit the second set of image elements at a second, different viewing position of the resultant variable image.

In accordance with a yet further aspect of the invention there is provided a method of manufacturing a holographic image layer for a security device, comprising: providing a holographic recording medium; providing first and second overlapping patterns of elements, and; holographically recording, in the holographic recording medium, the resultant variable image generated by illuminating the first and second overlapping patterns of elements, wherein; the pitches and/or relative rotations of the first and second patterns of elements and their relative locations are such that the first pattern of elements cooperates with the second pattern of elements to generate a magnified version of at least a part of the first pattern of elements due to the moiré effect, and further wherein; at least one of the first and second patterns of elements comprises a first area having a first pitch along at least one axis and a second area having a second, different pitch along said axis, whereby the moiré effect causes different degrees of magnification of the first pattern of elements to occur, such that a viewer of the resultant variable image perceives areas of different depth corresponding to the first and second areas.

In accordance with a yet further aspect of the invention there is provided a method of manufacturing a holographic image layer for a security device, comprising: providing a holographic recording medium; providing first and second overlapping patterns of elements, and; holographically recording, in the holographic recording medium, the resultant variable image generated by illuminating the first and second overlapping patterns of elements, wherein; the pitches and/or relative rotations of the first and second patterns of elements and their relative locations are such that the first pattern of elements cooperates with the second pattern of elements to generate a magnified version of at least a part of the first pattern of elements due to the moiré effect, and further wherein; the holographic image layer comprises a volume hologram.

### BRIEF DESCRIPTION OF THE DRAWINGS

Examples of the present invention will now be described with reference to the attached drawings, in which:

FIG. 1 shows an exemplary security device disposed on a substrate;

FIG. 2a is a schematic illustration of a geometry for recording a H1 master hologram in a conventional H1/H2 hologram recording technique;

FIG. 2b is a schematic illustration of a geometry for using the H1 to form a surface relief H2 hologram;

FIG. 2c is a schematic illustration of a geometry for using the H1 to form a volume H2 hologram;

FIGS. 3a to 3c schematically illustrate example geometries for recording a volume hologram;

FIGS. 4a and 4b illustrate an example sampling plate;

FIGS. 5a and 5b illustrate an example artwork plate;

FIG. 6 schematically illustrates a variable image exhibited to a viewer;

FIG. 7 illustrates a further example artwork plate;

FIG. 8 schematically illustrates a further variable image exhibited to a viewer;

FIGS. 9a and 9b illustrate a further artwork plate;

FIGS. 10a and 10b illustrate a further sampling plate;

FIGS. 11a and 11b schematically illustrate a further variable image;

FIGS. 12a and 12b illustrate further examples of artwork plates;

FIGS. 13a and 13b schematically illustrate a further variable images;

FIGS. 14a and 14b illustrate a further sampling plate;

FIGS. 15a and 15b illustrate a further artwork plate;

FIG. 16 shows a frame of a further variable image;

FIG. 17 illustrates a further sampling plate;

FIGS. 18a and 18b show a further artwork plate;

FIG. 19 shows a frame of a further variable image;

FIG. 20 schematically illustrates indicia adapted to have a three dimensional appearance;

FIG. 21 is a magnified view of a further artwork plate;

FIG. 22 shows a further example of an artwork plate;

FIG. 23 shows a number of frames of a further variable image;

FIGS. 24a and 24b illustrate further examples of artwork and sampling plates;

FIG. 25 schematically illustrates a further variable image,

FIG. 26 is an example arrangement of a sampling plate comprising an array of focussing elements;

FIG. 27 is an example of an artwork plate that may be used with a sampling plate comprising an array of microlenses, and;

FIGS. 28 to 30 show varies ways in which a security device according to the invention may be incorporated into a security document.

### DETAILED DESCRIPTION

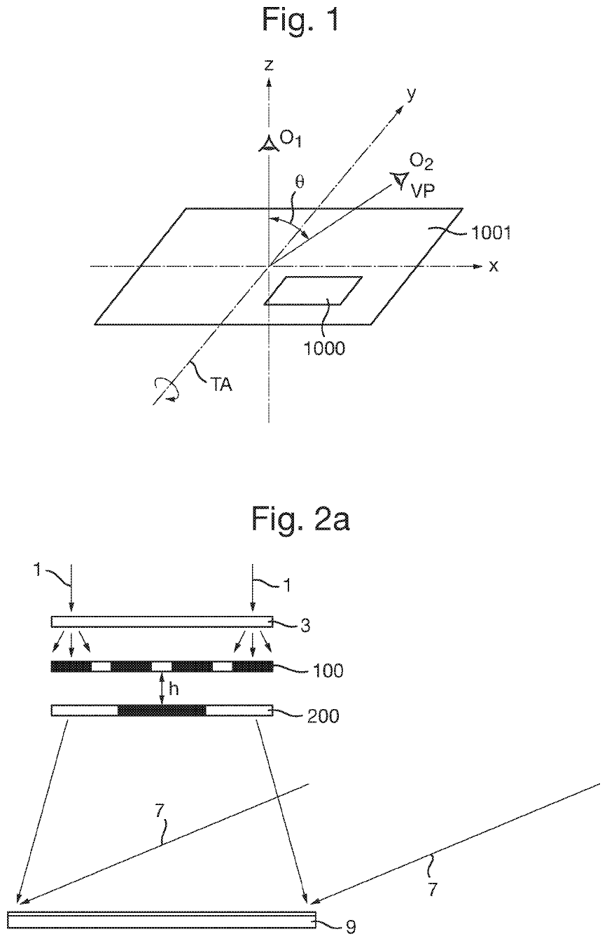

For ease of reference, the description below will refer to certain directions using the notation depicted in FIG. 1. FIG. 1 shows an exemplary security document 2000 (such as a credit card) comprising a security device 1000 disposed on a substrate 1001 which sits in a substantially planar surface defined by X and Y orthogonal axes. The third orthogonal Z axis is normal to the plane of the device, and as such an observer (O₁) viewing the device 1000 from any position along the Z axis has a normal viewing position. An observer O₂ at an arbitrary viewing position (VP) away from the normal is shown in FIG. 1. The viewing position VP is defined by the angle Θ (“tilt angle” or “viewing angle”) between the viewing position VP and the normal (Z axis). The change in viewing position is typically effected by an observer tilting the document (and therefore the device) about a tilt axis TA (in FIG. 1 the tilt axis being the Y axis).

For simplicity the following description will refer to tilting along either the X or Y axis in the geometry of FIG. 1, although it will be appreciated that other tilt axes within the X-Y plane are possible. The terms “hologram” and “holographic image layer” are interchangeable in the following discussion.

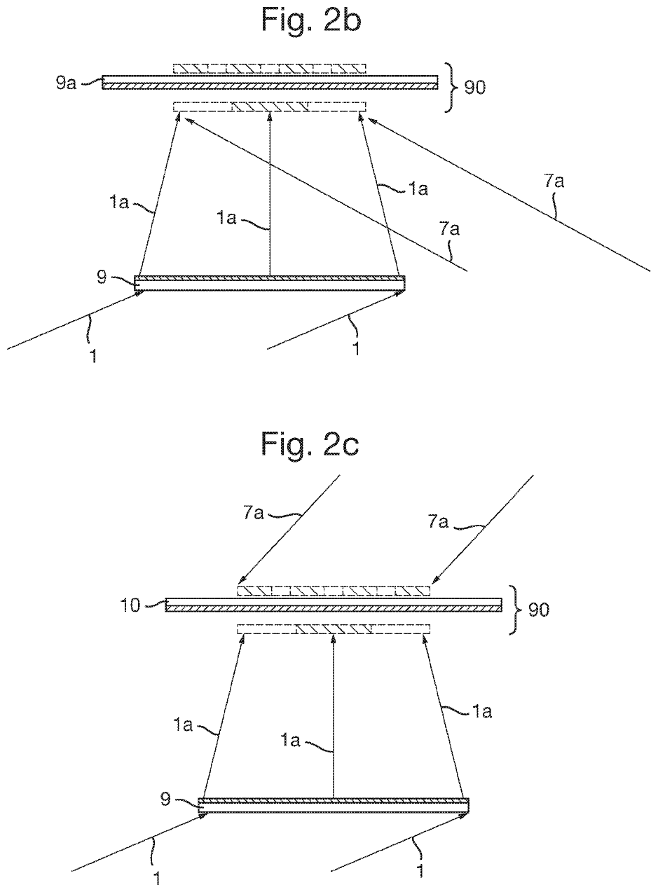

FIG. 2a is a schematic illustration of the geometry for recording a H1 master hologram in a conventional H1/H2 hologram recording technique. An object laser light beam (shown at 1) is incident on and directed through a light diffusing plate 3, and through overlapping first 100 and second 200 patterned plates, which are typically separated by a distance h. This distance is variable and is selected dependent on the degree of synthetic magnification and perceived depth required in the final replayed image, but is typically between 0.05 mm and 10 mm, with the typical separation for a rainbow embossed hologram being in the range on 2-10 mm. Each patterned plate comprises a pattern of elements that cooperate with each other such that a phase interference and/or moiré pattern is formed on the H1 hologram plate 9, which is typically coated with a silver halide emulsion. A reference light beam (shown at 7) of collimated laser light that is coherent with the object beam is directed onto the H1 plate 9 in off-axis geometry. A H2 copy (or copies) can subsequently be produced from the master H1 as is known in the art, and example geometries for this are show in FIGS. 2b and 2c.

FIG. 2b illustrates a typical geometry used to generate a H2 resist master 9a for a typical off-axis surface relief (embossed) hologram, such as a Benton slit rainbow hologram. The H1 plate 9 is illuminated with a conjugate reference beam 1, and the resultant image beam 1a illuminates the H2 resist master 9a (the holographic image projected by the master H1 is shown at 90). A H2 reference beam 7a is also used to illuminate the H2, with both the image beam la and the reference beam 7a impinging on the H2 from the same side. The planes of interference generated by the holographic interference between the image 1a and reference 7a beams will be parallel to the bisector of the wave vector for each beam. Where these planes intercept the resist surface of the H2 will determine the grating spacing and orientation of the surface relief structure. In the case of a rainbow hologram, the image beam 1a will be directed through a Benton slit.

FIG. 2c illustrates a projection geometry that may be used to record an off-axis volume hologram 10 from the H1. The main difference between this geometry and that explained above in FIG. 2b is that the H2 reference beam 7a impinges on the H2 hologram 10 from the opposite side to the image beam 1a to form interference fringes which typically make a smaller angle with the H2 than the corresponding surface relief hologram geometry shown in FIG. 2b.

For a general literature discussion of holographic H1/H2 transfer techniques a suitable reference text is “Practical Holography”, Graham Saxby, published by Prentice Hall Int. (UK) Ltd. 1988.

For ease of reference in the following, the first patterned plate 100 will be referred to as the “artwork plate”, and the second patterned plate 200 will be referred to as the “sampling plate” as discussed above in the summary of the invention section.

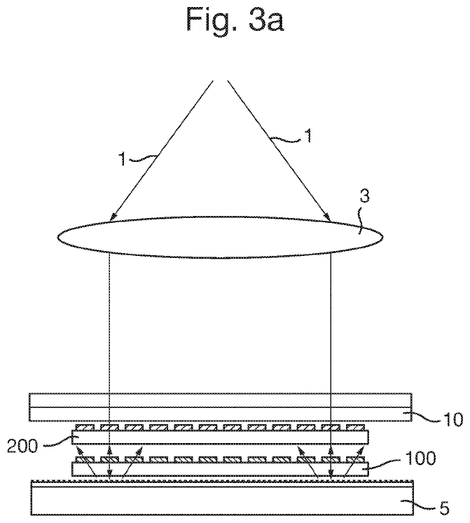

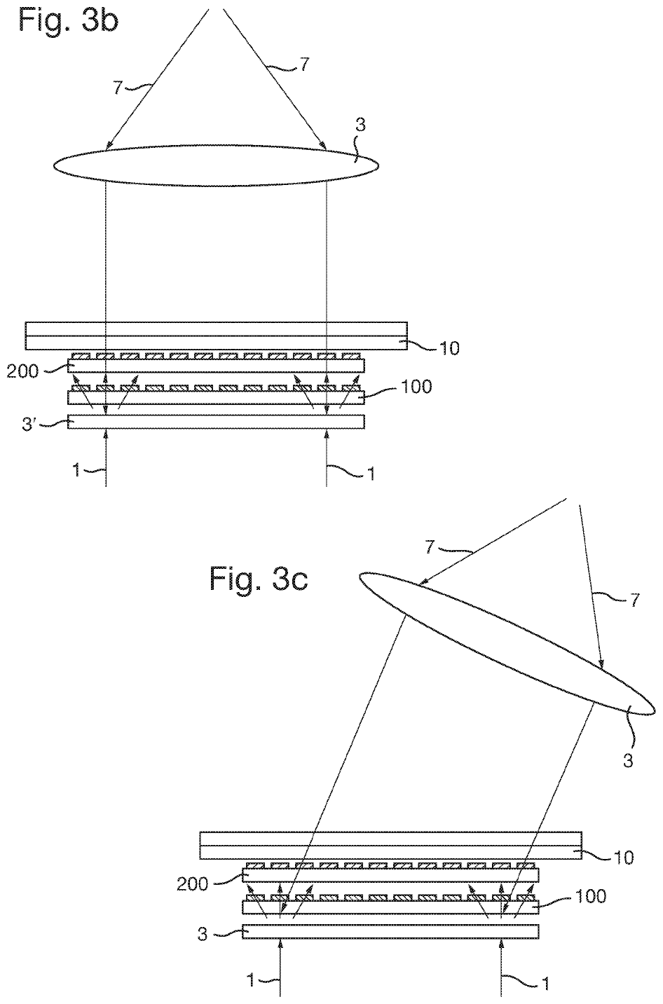

FIG. 3a schematically illustrates an example geometry for directly recording an on-axis reflection volume hologram. A laser light beam 1 is incident on and directed through a light diffusing plate 3. The light beam 1 travels through the sampling 200 and artwork 100 plates before being reflected from a back reflector 5. The reflected beam (acting as the object beam) subsequently travels though artwork plate 100 and sampling plate 200, generating a phase interference and/or moiré pattern that is recorded in master volume hologram 10. In this geometry the light beam travelling through the plates before being reflected from the back reflector acts as the reference beam.

FIG. 3b schematically illustrates an alternative geometry for directly recording an on-axis reflection volume hologram. Here, a second light diffusing plate 3′ is provided in place of the back reflector 5 of FIG. 3a, and an object laser light beam 1 is directed through the artwork plate 100 and sampling plate 200 to generate a phase interference and/or moiré pattern that is recorded on the master volume hologram 10. A reference beam 7 that is coherent with the object beam is provided in on-axis geometry. FIG. 3c schematically illustrates the case where the object beam 7 is provided in off-axis geometry.

In each of these cases, the resulting hologram 10 is used in the security device 1000 such as that seen in FIG. 1. Upon illumination of the security device, the hologram (or “holographic image layer”) diffracts incident light in order to exhibit a holographic version of the variable effect produced by the overlapping plates 100, 200 to an observer of the device.

The invention will be described with reference to a number of example effects exhibited by holographic image layers. However, these are not limiting, and the skilled person will understand that features of different examples may be combined.

### First Example

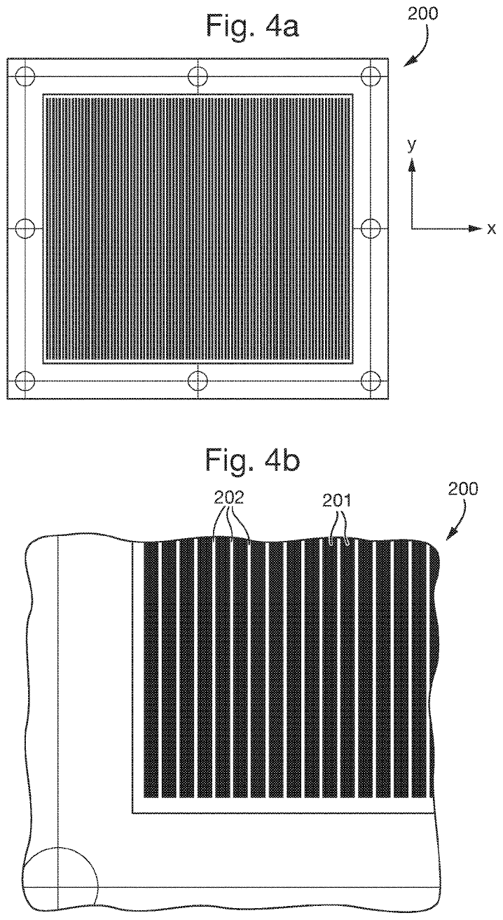

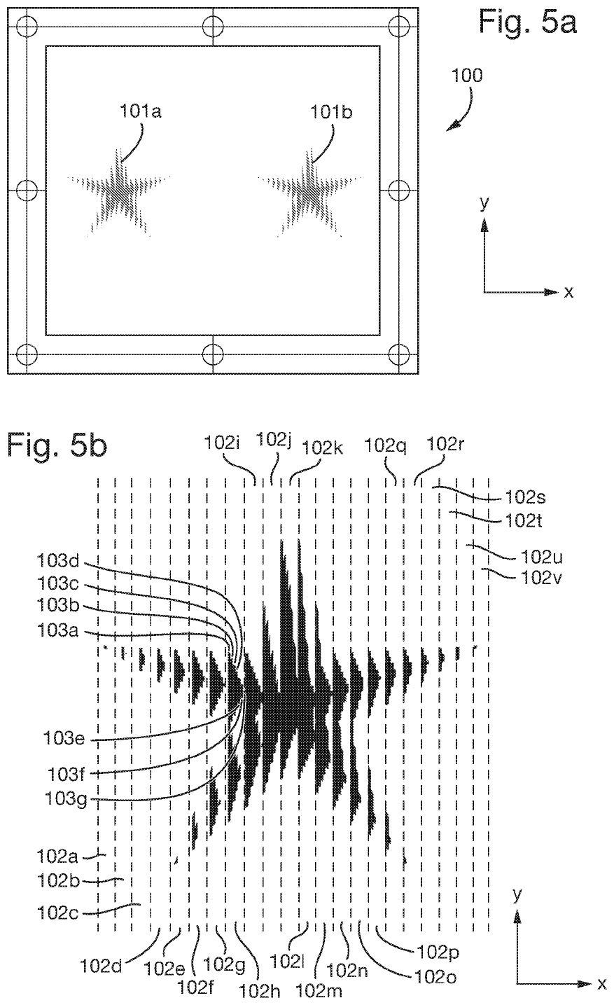

FIG. 4a is an example sampling plate 200 and FIG. 5a is an example artwork plate 100 that may be used according to a first example of the invention in order to provide a phase interference effect. The sampling plate 200 illustrated in FIG. 4a (with a magnified view shown in FIG. 4b) comprises a regular array of substantially opaque rectangular elements 201 having their long axes directed along the Y axis. The rectangular elements 201 are separated along a direction perpendicular to their long axes (i.e. separated along the X axis). The rectangular elements 201 are substantially opaque, with the gaps 202 between the rectangles being substantially transparent to visible light such that light from the artwork plate can pass through. In this example each rectangular element 201 has a width of 600 μm and the rectangular elements are separated by gaps 202 of 100 μm.

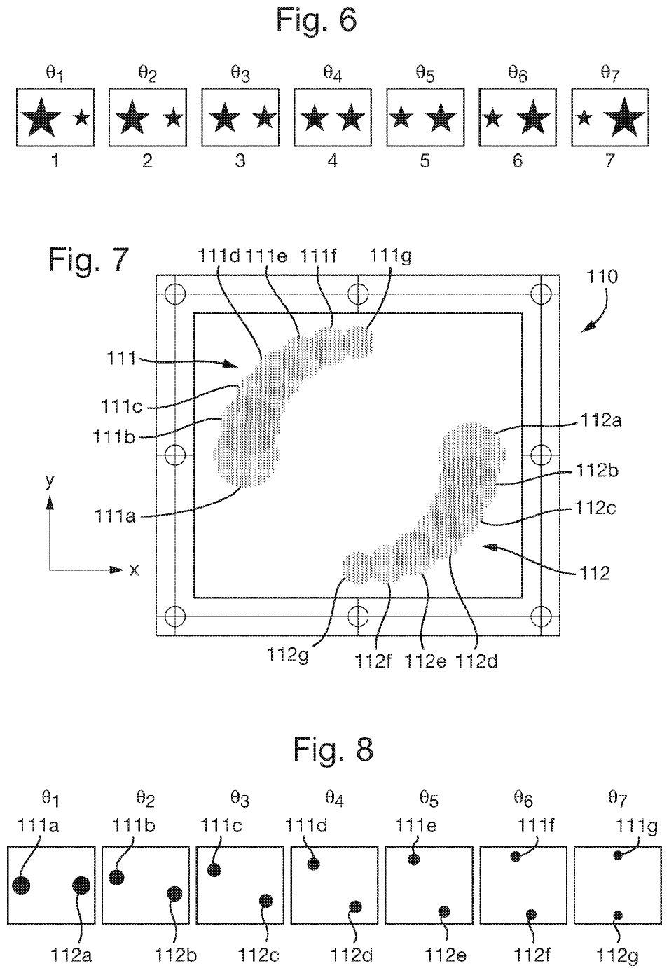

The artwork plate 100 illustrated in FIG. 5a comprises two spaced apart star-shaped indicia 101a, 101b, with FIG. 5b illustrating a magnified view of star 101a. As can be seen in FIG. 5b, the star 101a is comprised of a plurality of sections 102a, 102b . . . 102v, with specific sub-sections (“segments”) of the star being viewable through the gaps 202 of the sampling plate 200 at different viewing angles. The resultant hologram exhibits the effect seen in FIG. 6, where for different viewing angles (Θ₁-Θ₇) when the device (and therefore the hologram) is tilted about the Y axis, different size stars 101a, 101b are replayed. The size ratio between the opaque and transparent areas of the sampling plate 200 control the number of frames that are replayed upon tilting the device—in this instance there are seven different frames that are exhibited.

Take for example the viewing angle Θ₁, where the left star 101a is exhibited at its maximum size, and the right star 101b is exhibited in its minimum size. Referring back to FIG. 5b, each section of the star comprises up to seven segments. For example section 102h comprises segments 103a, 103b, 103c, 103d, 103e, 103f, 103g, each having different vertical heights. Segment 103a corresponds to the frame seen at viewing angle Θ₁ where the star 101a is exhibited at its maximum size, and segment 103g corresponds to the frame seen at viewing angle Θ₇ where the star 101a is exhibited at its minimum size. In other words, referring to only section 102h for ease of reference, at viewing angle Θ₁, segment 103a is viewable through the gaps 202 in the sampling plate 200; at viewing angle Θ₂, segment 103b (which is smaller than 103a) is viewable through the gaps 202 in the sampling plate 200, and so on until at viewing angle Θ₇, segment 103g is viewable through the gaps 202 in the sampling plate. The parallax allows the sampling plate to sequentially reveal each one at a time when the hologram is tilted about the Y axis.

Right star 101b is composed of sections and segments in a corresponding manner such that the final security device, when tilted about the Y axis, displays the seven frames illustrated in FIG. 6, with one star increasing in size whilst the other star correspondingly decreases in size in order to provide a striking visual effect. Under diffuse light, this effect is minimised and the general shape of the stars at their maximum size are visible (i.e. all the segments of both stars are visible), as seen in FIG. 5a. However, under spot light, each of the seven frames is individually visible upon tilting the device. This change in appearance of the device under different lighting conditions advantageously increases the security level of the device.

### Second Example

FIG. 7 illustrates an alternative artwork plate 110 that may be used with the sampling plate 200 described above. Again, the exhibited effect will be a phase interference effect. Artwork plate 110 comprises two arrays 111, 112 of overlapping circles arranged in a curved manner. Array 111 comprises circles 111a, 111b . . . 111g and array 112 comprises circles 112a, 112b . . . 112g. Each circle is comprised of an array of vertical segments (directed along the Y axis), with the arrays of each circle being offset from each other such that at a particular viewing angle of the resulting hologram, only one circle of each array 111, 112 is visible. This exhibits an animation effect with the circles appearing to change in position and size upon tilting of the hologram about the Y axis, as schematically illustrated in FIG. 8. As before, this arrangement of artwork and sampling plates generates seven frames seen at viewing angles Θ₁ to Θ₇. Under diffuse light, this effect is minimised and the general shape of the circle arrays is visible, as is FIG. 7.

### Third Example

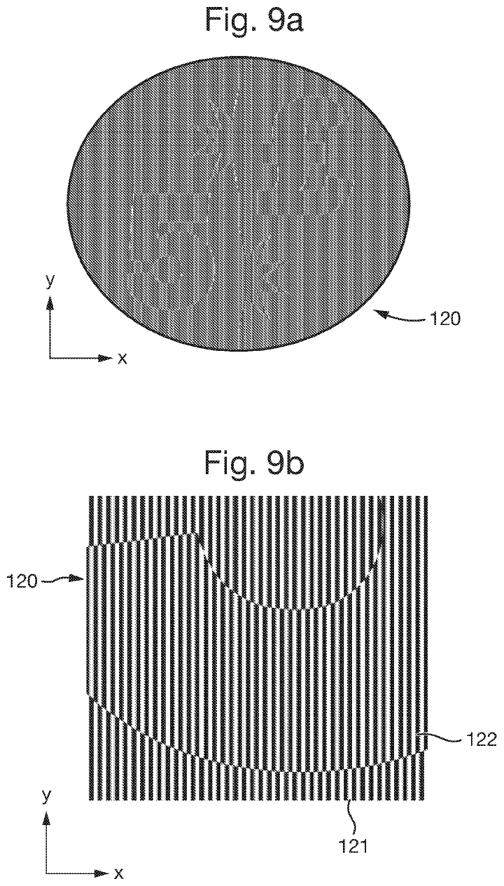

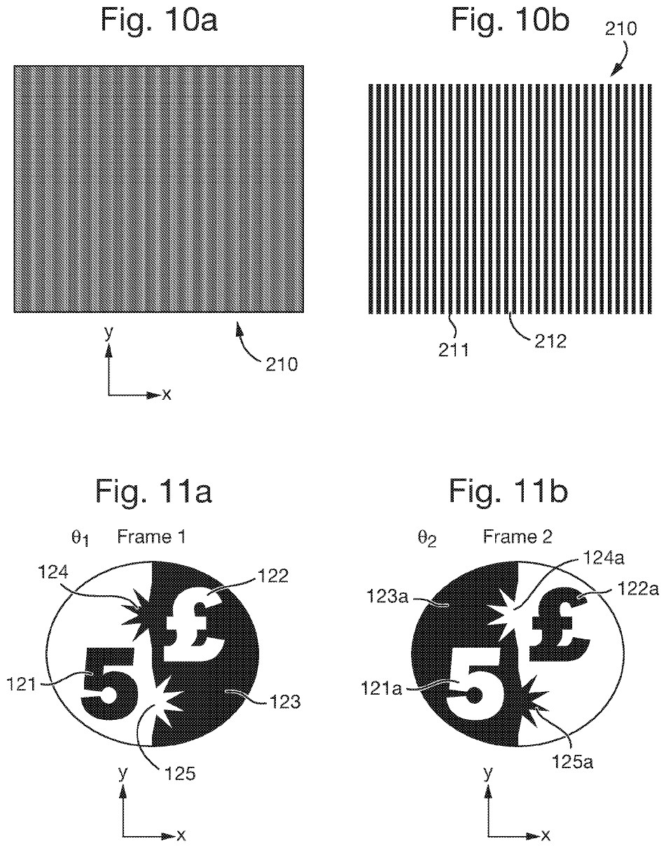

FIG. 9a illustrates an artwork plate 120 that may be used with sampling plate 210 (illustrated in FIG. 10a) in order to produce a striking “contrast switch” phase interference effect that is illustrated in FIGS. 11a and 11b. As seen in FIG. 11a, at a first viewing angle Θ₁ of the device 100, a first pattern of indicia is exhibited. More specifically, a shaded “5” symbol 121 is displayed against a light background, a shaded region 123 outlines a light “£” symbol 122, and two star shapes 124, 125 are exhibited. At a second viewing angle of the device, Θ₂ (e.g. tilting the device about the Y axis), the same symbols are exhibited but the light and shade are reversed.

In contrast to the first and second embodiments, only two frames are visible here, as the sampling plate 210 comprises an array of substantially opaque rectangular elements 211 (see FIG. 10b) that are spaced apart by a distance equal to the width of each rectangular element. In other words, the substantially transparent “gaps” 212 between the rectangular elements and the rectangular elements themselves are substantially the same width.

The artwork plate 120 comprises two arrays 121, 122 of substantially rectangular elements as illustrated in the magnified view of artwork plate in FIG. 9b. The two arrays of the artwork plate are offset from each other such that at the first viewing angle Θ₁ only the first array is visible through the substantially transparent gap regions 212 of the sampling plate 210, and at the second viewing angle Θ₂ only the second array is visible through the gaps of the sampling plate 210.

Again, under diffuse light, the “contrast switch” effect will be minimised, with the general shape of the artwork plate being visible (FIG. 9a).

### Fourth Example

The above examples have been directed to examples of phase interference effects that may be utilised in the present invention. Alternatively or in addition, the overlapping artwork and sampling plates can also be used to create moiré magnification effects when viewing the final security device, as will be explained in the following.

The degree of magnification achieved is defined by the expressions derived in “The Moire Magnifier”, M. Hutley, R Hunt, R Stevens & P Savander, Pure Appl. Opt. 3 (1994) pp. 133-142. To summarise the pertinent parts of this expression, suppose the pitch of the elements of the artwork plate is A and the pitch of the elements of the sampling plate is B, then the magnification of the artwork plate elements, M is given by:

M=A/SQRT[(B cos(Theta)−A)²−(B sin(Theta))²], (Eq. 1)

where Theta equals the angle of rotation between the elements of the artwork and sampling plates.

For small Theta such that cos(Theta)˜1 and sin(Theta)˜0 and for the case where B≠A, we have,

M=A/(B−A). (Eq. 2)

As we can see from Eq. 2 therefore, if the artwork plate comprises an array of indicia that are compressed along an axis that is perpendicular to the long axis of the sampling plate elements, then the indicia will appear magnified along that axis when viewed through the sampling plate.

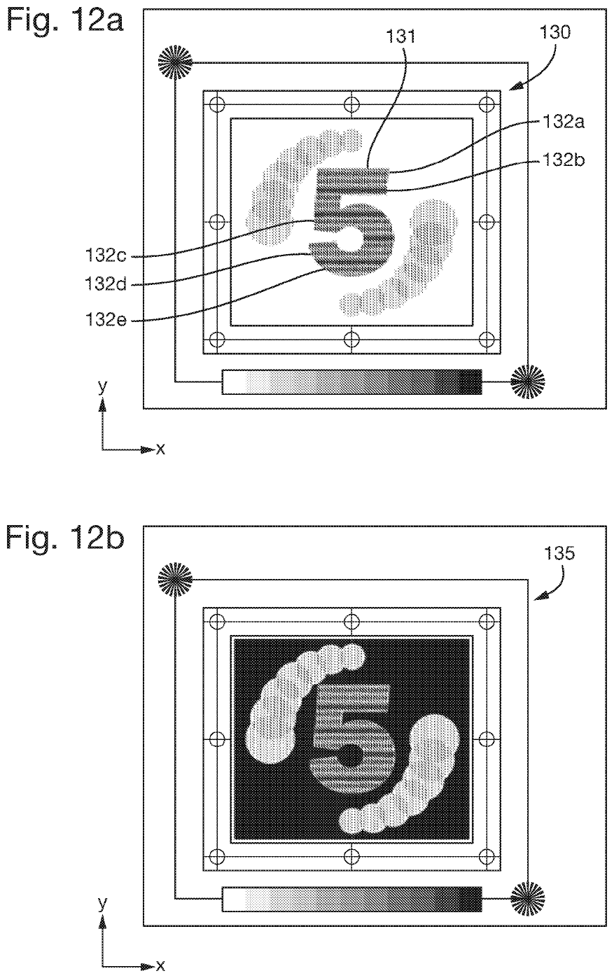

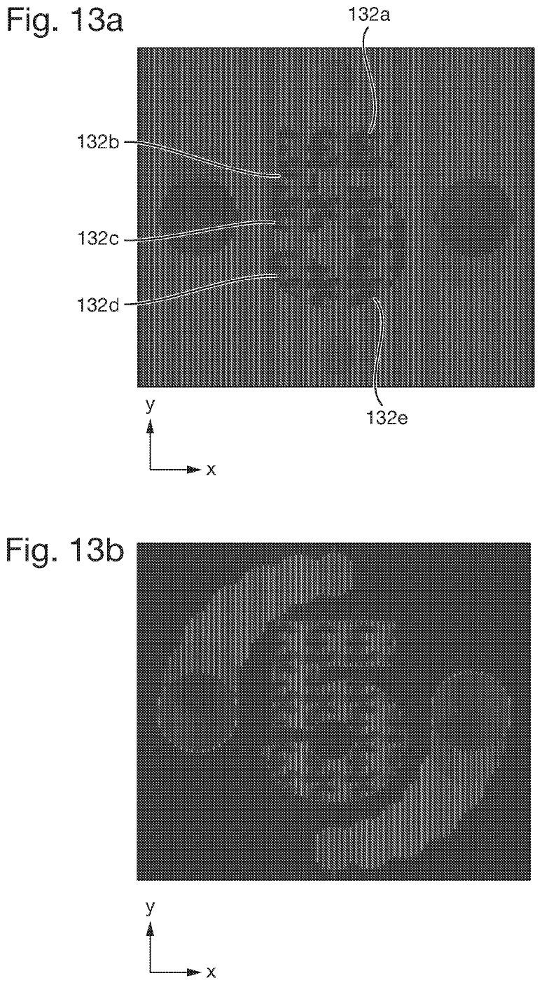

This effect is illustrated in FIGS. 12 and 13. FIG. 12a illustrates an artwork plate 130 that comprises two arrays of overlapping circles arranged in a curved manner as in the plate 110 seen in FIG. 7. Additionally, the artwork plate 130 comprises a “5” symbol in outline, within which are a plurality of arrays 132a, 132b, 132c, 132d, 132e of “£” symbols. The individual “£” symbols are compressed in a direction along the X axis and are regularly spaced.

In this specific example, each “£” symbol has a width (i.e. a dimension along the X axis) of 547 μm, and the spacing of the symbols is a constant 70 μm. The sampling plate is the plate 200 illustrated in FIG. 4a, having a regular array of 600 μm wide rectangular elements separated by 100 μm wide substantially transparent regions. The rectangular elements 201 of the sampling plate and the “£” symbols are aligned along the same (Y) axis (i.e. no rotational offset) and so we may use Eq. 2 to calculate the magnification of the artwork plate “£” indicia. Accordingly, when viewing through the sampling plate 200, the magnification of the “£” symbols is 617/(700−617)=7.4×, giving an exhibited width of 4.1 mm in the replayed hologram image.

Therefore, when viewing the final hologram image exhibited by the device, the viewer perceives the animation effect of the circles as in the second embodiment, together with 4.1 mm wide “£” symbols appearing to have fast movement along the X axis upon tilting the hologram about the Y axis. The apparent movement of the “£” indicia is due to the fact that changing the viewing angle causes the sampling plate to sample different parts of the artwork plate. The magnification of the “£” symbols also provides perceived depth of the final image, providing a striking effect to the viewer. FIG. 13a illustrates the centre-view combined effect of the artwork 130 and sampling 200 plates, where the magnified “£” symbols in the arrays 132a, 132b, 132c, 132d, 132e are easily seen.

However, as also visible in FIG. 13a, under spotlight conditions, the vertical rectangular elements 201 of the sampling plate 200 are visible, which is generally an undesirable artefact in the final image exhibited by the hologram. In order to minimise this undesirable artefact and yet still maintain the moiré effects, an alternative artwork plate 135 may be used as illustrated in FIG. 12b. In this artwork plate, the area of the plate surrounding the active areas (i.e. the “5” and the two arrays of circles) is masked, ensuring that the elements of the sampling plate 200 are not visible in this area in the final hologram, as seen the FIG. 13b, which is the centre-view combined effect of the alternative artwork plate 135 and sampling 200 plates. The area around the active elements remains clear and allows the application of any other holographic backgrounds (depth, greyscale etc. . . . ) or other holographic elements without being affected or masked by the sampling plate. The sampling plate 200 in this example comprised substantially opaque 600 μm wide rectangular elements separated by 100 μm gaps. However, the appearance of the sampling plate elements in the final image may be mitigated by using thinner elements in the sampling plate, for example rectangular elements having a width of 210 μm. In order to maintain the seven frame condition, such elements would have to be spaced apart by a constant 35 μm.

When viewing the hologram under very diffuse light, there is an inherent mixing of all of the replayed holographic frames, and all of the frames are visible, with the general shape of the array of circles and the “5” being visible as a darker part of the colour background. Under spot light however, only certain frames (and ultimately single frames) replay at any given viewing angle, making the moiré effects appear far more clearly. This difference in exhibited optical effect under different lighting conditions advantageously provides a secondary security feature (“level two security feature”) in addition to the difficulty in reoriginating the hologram.

### Fifth Example

In the embodiments described above, the sampling plate 200 comprised a plurality of equally-spaced rectangular elements. By varying the spacing of the elements of the sampling plate, we can achieve further optical effects in the final hologram image, such as varying the magnification power, the rate of movement of indicia defined in the artwork plate upon tilting the hologram, and also the apparent depth of the indicia of the artwork plate. The sampling plate can be non-constant and exhibit a variation of the width of the opaque or transparent areas (or both). Taking the previously discussed sampling plate 200 as an example, the opaque rectangular elements 201 and/or the gaps 202 may vary in width (dimension along the X axis). Such variation may be linear, sinusoidal or any other mathematical function, and when combined with an artwork plate having indicia of constant width and spacing, will exhibit variable magnification in the final holographic image.

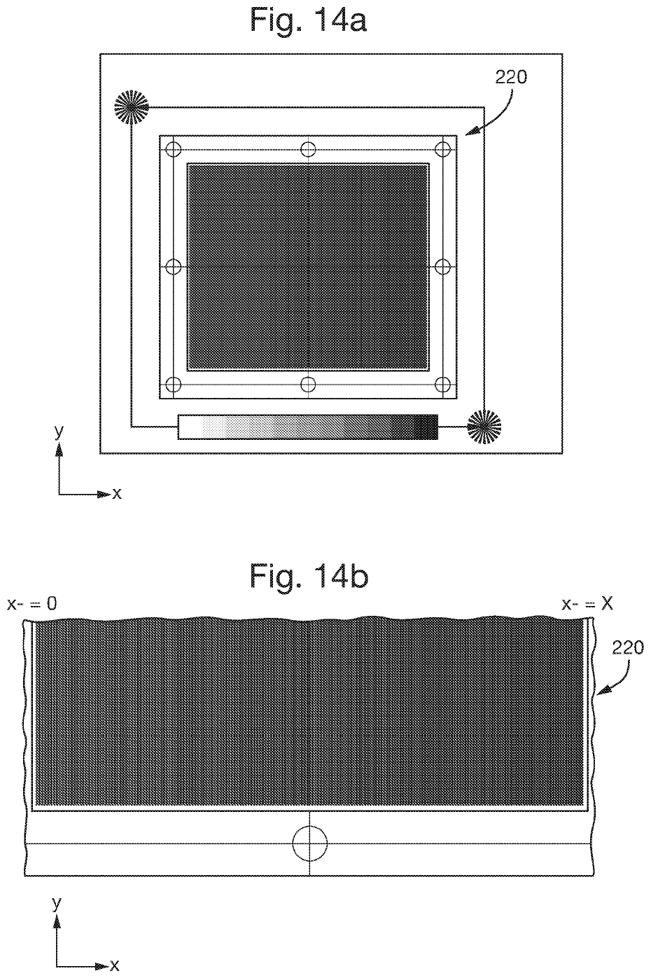

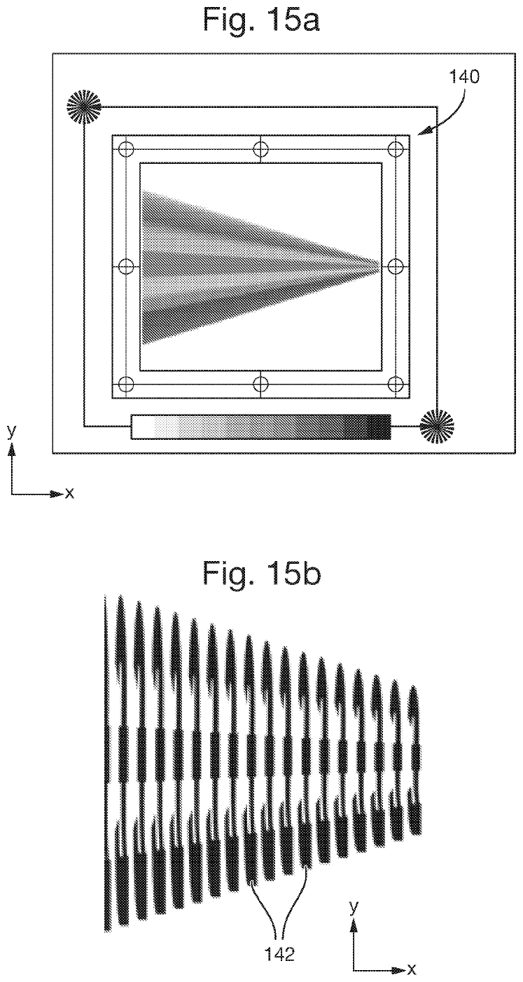

FIGS. 14a and 14b illustrate such a non-constant sampling plate 220. The sampling plate is comprised of a plurality of substantially opaque rectangular elements having their long axes along the Y axis. The elements are spaced apart along the X axis in a linearly variable manner. Each element has a width of 210 μm with the gaps between the elements varying linearly from 58 μm at x=0 to 30 μm at x=X (see FIG. 14b).

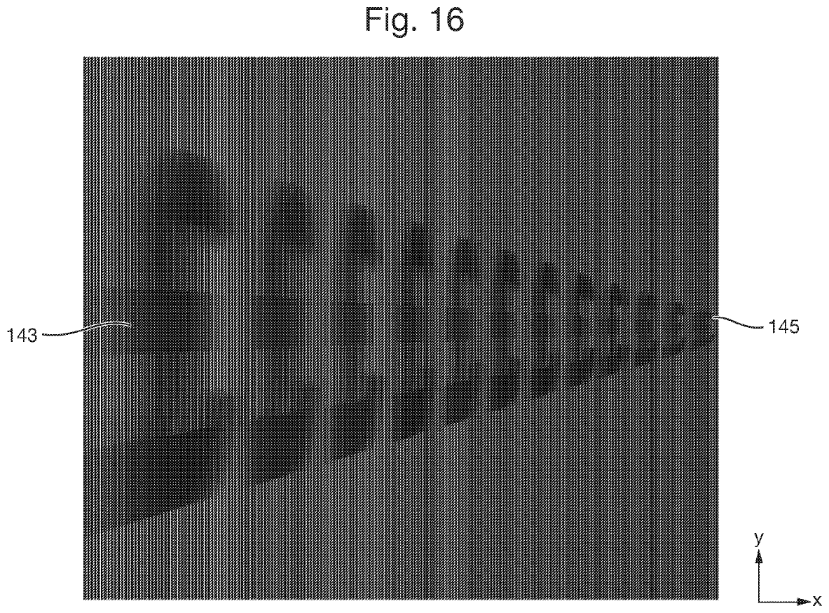

FIG. 15a illustrates an example artwork plate 140 comprising an array of 200 μm wide “£” indicia 142, each of which have been compressed along the X axis (see FIG. 14b), and varying in height along the Y axis. The separation between each “£” symbol along the X axis is constant 70 μm. A frame of the hologram image exhibited by the combination of the artwork plate 140 with the sampling plate 220 is illustrated in FIG. 16. Here the left-most “£” symbol 143 exhibits the strongest absolute magnification and appears forward with respect to the plane of the hologram, whereas the right-most “£” symbol 145 exhibits the smallest absolute magnification and appears closer to the plane of the hologram (although still forward).

This depth effect can be explained by using Eq. 2 above, where the absolute magnification of the left-most “£” symbol 143 in a given frame of the hologram image is given by M=270/(268−270)=−135×. The absolute magnification of the right-most “£” symbol 147 is given by M=270/(240−270)=−9×. Note that both of these absolute magnification values are negative, hence the inversion of the “£” indicia in the artwork plate 140 such that they appear correctly orientated in the final hologram image.

The apparent “depth” of the indicia elements in the final image relative to the surface plane (i.e. the plane of the hologram) derives from the familiar lens equation relating magnification of an image located a distance V from the plane of a lens of focal length f, this being,

M=V/f−1. (Eq. 3)

In this instance, the distance between the artwork plate and the sampling plate (which is a constant) substitutes for the focal length in Eq. 3. Therefore, from Eq. 3, we can see that the apparent depth (V) of the left-most indicia symbol 143 is more forward (i.e. more negative) than that of the right-most indicia symbol 145.

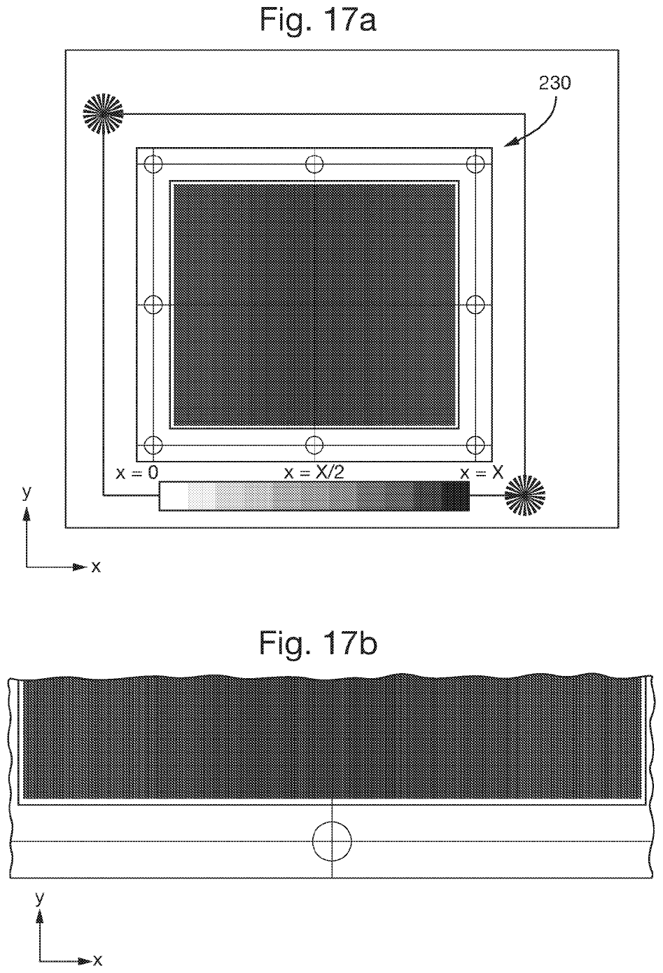

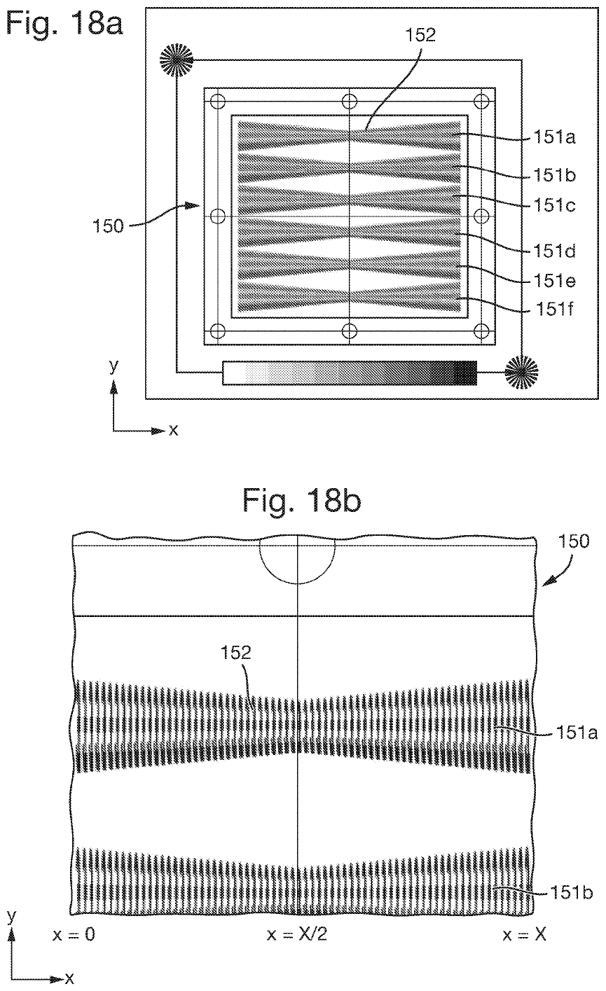

FIG. 17 illustrates a sampling plate 230 comprising a plurality of substantially opaque rectangular elements having their long axes arranged along the Y axis. The elements are spaced apart along the X axis in a linearly variable manner. Each element has a width of 210 μm with the gaps between the elements varying linearly from 50 μm at x=0 to 30 μm at x=X/2 and back to 50 μm at x=X. FIG. 18a illustrates an artwork plate 150 comprising a plurality of arrays 151a, 151b, . . . 151f of “£” indicia 152. These are more clearly seen in FIG. 18b which is a magnified view of the arrays 151a and 151b. Each indicia element has a width (in the X direction) of 200 μm and are separated by a constant 70 μm. As can be seen, the height of the indicia elements continuously varies from a maximum at x=0 to a minimum at x=X/2 and back to a maximum at x=X.

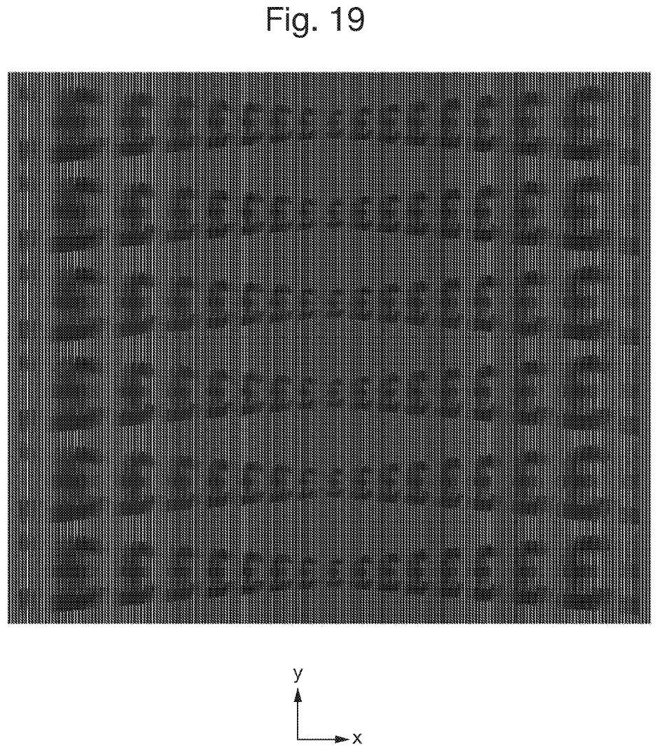

An image frame exhibited by the hologram generated by the overlapping artwork plate 150 with the sampling plate 230 is illustrated in FIG. 19, where the outermost indicia elements of the frame appear forward with respect to the plane of the hologram, and the central indicia elements appear closer to the plane of the hologram. Similarly to above, this effect can be explained through the use of Eq. 2 and Eq. 3, with the outermost indicia replaying with the largest absolute magnification (note that this is negative hence the inverted indicia in the artwork plate 150), and replaying with an apparent depth that is more forward of the hologram plane.

When the security device is tilted about the Y axis, the “£” indicia appear to move along the X axis due to the sampling effect of the sampling plate 230. This provides a particularly striking effect to a viewer. In general, the rate of motion is proportional to the perceived image depth. Therefore, generally, the greater the absolute magnification of the indicia, the faster the apparent movement of the indicia upon tilting of the device.

The above examples use an artwork plate having array(s) of indicia of constant spacing together with a sampling plate comprising regions of different spacing in order to provide the differing depth effects in the final hologram image. However, it will be appreciated that the equivalent effects may be provided using indicia in the artwork plate having varying spacing and a sampling plate having constant spacing (see for example the sixth embodiment below). Furthermore, in some embodiments both the sampling and artwork plates may comprise elements having varying spacing.

### Sixth Example

Different apparent depths of indicia exhibited in the hologram image can be utilised in order to display objects which appear three dimensional. Consider an indicia element 161 in the shape of a star (see FIG. 20). If we split the star 161 into a plurality of separate elements (here three concentric star elements 162, 163, 164), and replay each element such that it appears at a different depth in the hologram image, then the combined star indicia element 161 will appear three dimensional in the hologram image.

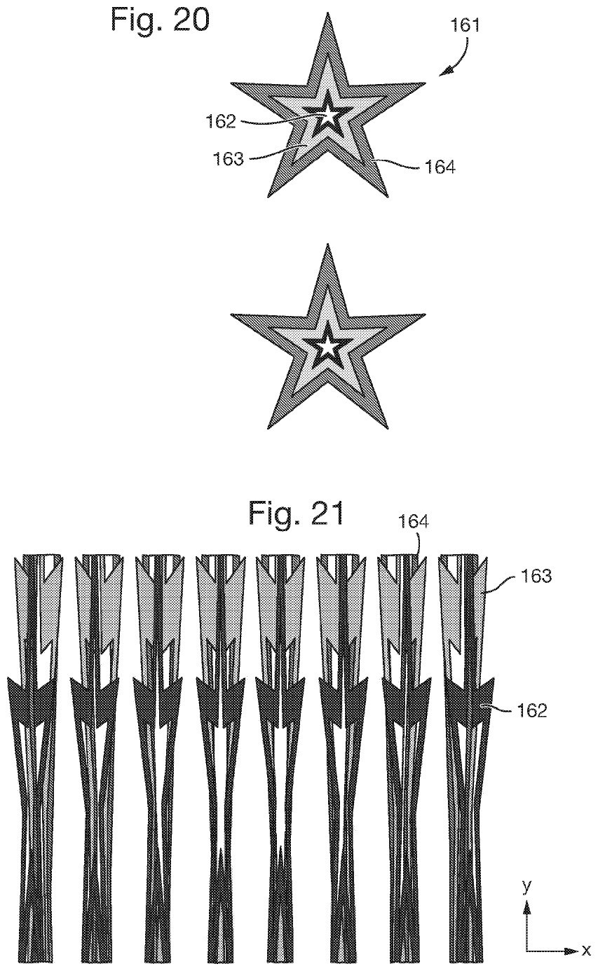

FIG. 21 illustrates a magnified section of a suitable artwork plate 160 that may be combined with a constant spacing sampling plate in order to replay star indicia 161 having apparent three dimensional properties. The artwork plate comprises an array of inner star elements 162, an array of intermediate star elements 163 and an array of outer star elements 164, with the elements of each array having the same dimension along the X axis and being constantly spaced, but the spacing one of array differing from the spacing of another. In this example, each indicia element has a width of 200 μm, with the array of outer star elements having the smallest spacing at 50 μm, the array of intermediate star elements having a spacing of 55 μm and the array of outer star elements having the largest spacing at 65 μm. The sampling plate used comprises an array of 210 μm wide substantially opaque rectangular elements separated by a constant gap size of 35 μm.

The absolute magnification of the outer star elements 164, intermediate star elements 163 and inner star elements 162 is therefore −50×, −25.5× and −13.25× respectively (using Eq.2). Using Eq.3 we can therefore also see that the outer star elements 164 have the strongest absolute magnification and appear very forward with respect to the plane of the hologram, with the inner star elements 162 appearing forward of the plane of the hologram, but less so than the outer star elements. This therefore creates a striking three dimensional effect to a viewer of the hologram image, with parallax upon tilting the security device. It will be appreciated that with suitable gap dimensions between the individual elements of the artwork plate arrays, the hologram image may replay the star indicia appearing in the depth behind the plane of the hologram.

### Seventh Example

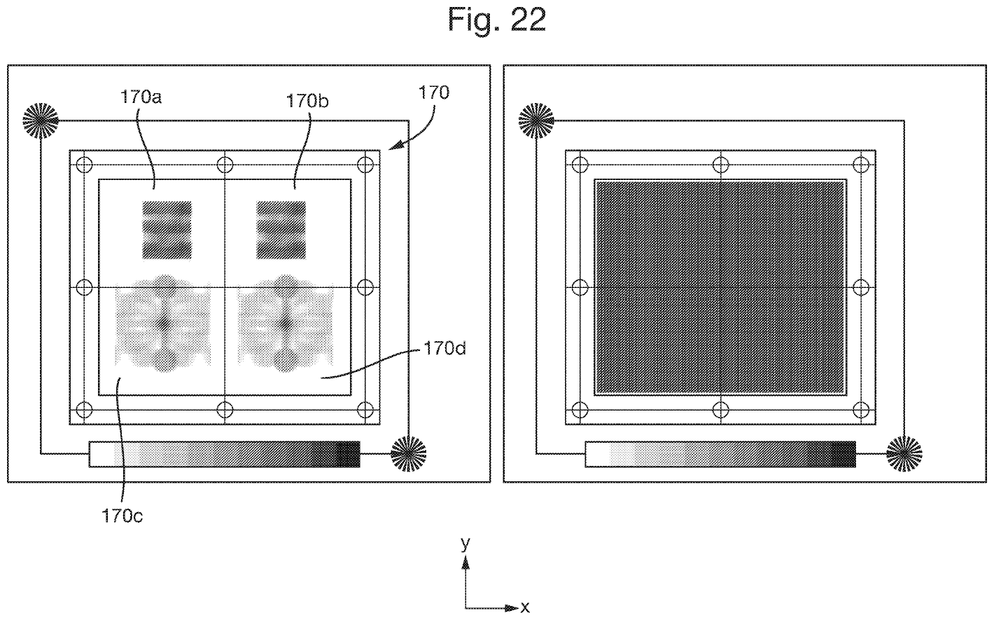

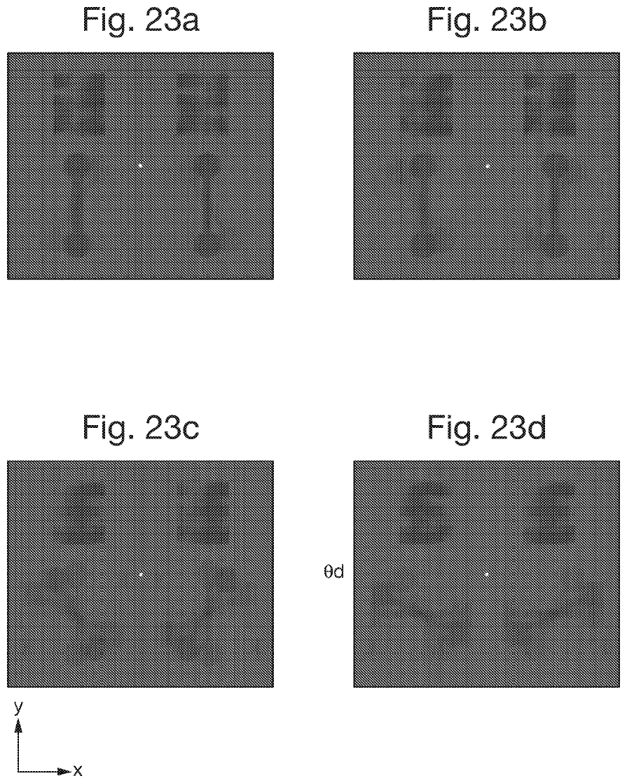

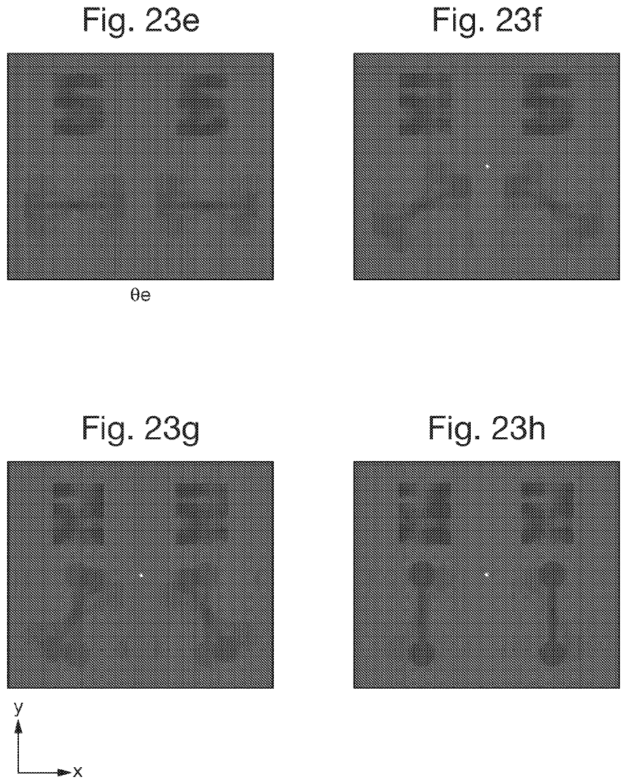

A particularly striking effect is provided to a viewer of the hologram when the holographic image replays a combination of the phase interference and moiré magnification effects that have been described above. FIG. 22 illustrates an example artwork plate 170 suitable for providing such an effect. The artwork plate 170 is divided into four quadrants 170a, 170b, 170c, 170d, and is designed to be used in conjunction with a sampling plate adapted to replay seven independent frames (for example the sampling plate used in the sixth embodiment above). The seven frames of the hologram image animation are illustrated in FIGS. 23a to 23f.

For ease of discussion we will now focus on the top left and bottom left quadrants and how they will replay in the final hologram image. The top left quadrant of the final hologram replays as switching between a “£” symbol and a “5” symbol upon tilting about the Y axis (for example see the top left quadrant in the frames of FIGS. 23(d) and 23(e). In a similar manner to the artwork plate of FIGS. 5a and 7, the quadrant 170a of the artwork plate comprises an array of elements that cooperate with the sampling plate such that certain segments are sequentially replayed upon tilting the hologram. Furthermore, each array of segments that is designed to be replayed at a particular viewing angle comprises an array of compressed elements that are magnified due to Moiré magnification by the sampling plate.

For example, at viewing angle Θ_{d}, the frame shown at FIG. 23(d) is replayed, where the top left quadrant of the image exhibits a “£” symbol. This “£” symbol is exhibited due to moiré magnification of an array of “£” symbols on the artwork plate that are revealed through the sampling plate at the viewing angle Θ_{d}. Similarly, at viewing angle Θₑ, a “5” symbol is replayed in the top left quadrant of the image frame, due to the moiré magnification of an array of “5” symbols on the artwork plate that are revealed through the sampling plate at the viewing angle Θₑ. In this specific example, the arrays of the artwork plate comprise individual elements (“£” or “5” symbols) having a width of 200 μm and a constant gap size of 40 μm, giving rise to a magnification of 48× and appear at a depth behind the plane of the hologram. The magnification also provides dynamic movement upon tilting the hologram about the Y axis.

The bottom left quadrant replays a rotating ball and stick 172 upon tilting the hologram. As described above with respect to the “£” and “5” symbols in the top left quadrant, each frame of the rotating ball and stick is due to an array of ball and stick elements of the artwork plate designed to be revealed through the sampling plate at that particular viewing angle. However, in the case of the ball and stick, the arrays at different viewing angles have different spacings such that the elements appear at different depths within the image at different viewing angles. In this specific example, the ball and stick appears at different forward planes throughout the animation, providing a further striking visual effect on top of the already memorable animation effects.

All of the above examples have used a sampling plate comprising a one dimensional line array, which provide parallax effects about one axis of tilt (e.g. tilting about the Y axis in the view of FIG. 1). However, the skilled person will appreciate that more complex effects may be generated by using more complex sampling plates (and corresponding artwork plates). For example, the sampling plate may comprises a dot pattern rather than a line pattern. Furthermore, the sampling plate may comprise a two dimensional line or dot pattern such that an observer views an image that is variable when the device is tilted about more than one axis. For example, a sampling plate may be provided having a series of substantially opaque elements arranged along both the Y axis (as in the examples above) and the X axis. When used with a corresponding artwork plate having sets of image elements arranged along the X and Y axes, then an observer will perceive variation in the image when tilting the device about the X axis and the Y axis. Such a two dimensional device is particularly suited to Lippmann (“volume”) holograms rather than H1/H2 holograms recorded using a Benton slit.

### Eighth Example

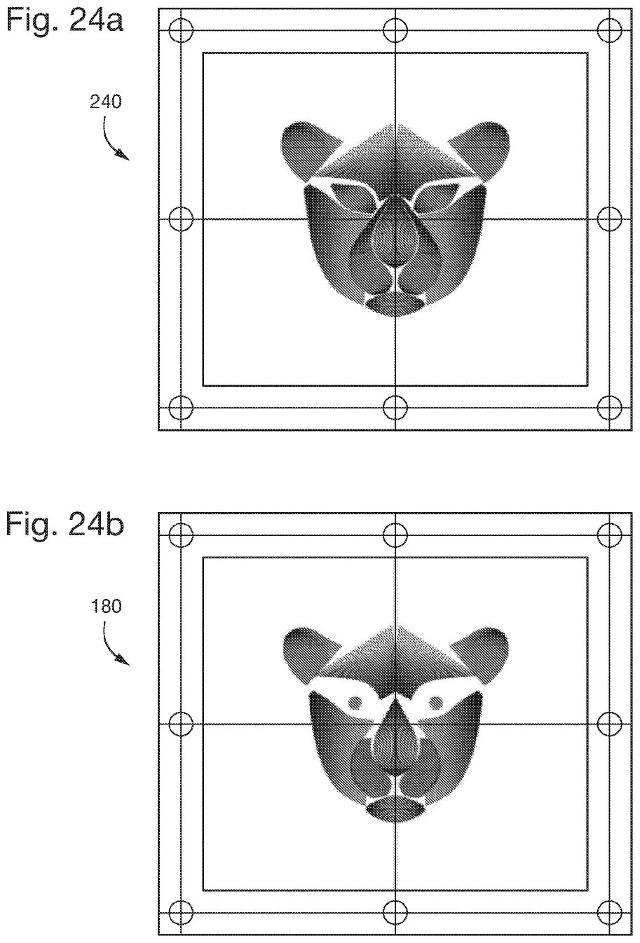

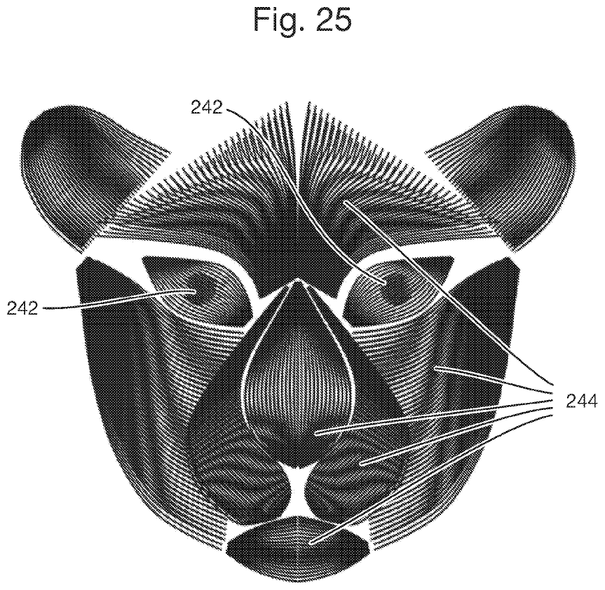

The use of complex designs for the artwork and sampling plates further increases the level of security associated with the device, as not only will would-be counterfeiters have to calculate the patterning through which the hologram was made, but also have access to tooling capable of generating the patterning. FIG. 24a illustrates an example sampling plate 240 having a complex two dimensional line pattern, in this case in the form of a tiger's head. FIG. 24b illustrates an example artwork plate 180 that cooperates with the sampling plate 240 in order to generate a complex moiré effect to be recorded in the holographic image layer. FIG. 25 illustrates a frame of the variable image exhibited by the device. The combination of the two plates generates the effects described above, for example moiré magnification of the pupils (shown at 242) and apparent dynamic movement upon tilting of the device (illustrated at 244). The overall effect exhibited to an observer of the device is one of dynamic texture and volume, providing a striking effect that is difficult to counterfeit.

### Ninth Example

In all of the examples described above, the sampling plate comprises a line pattern or a dot pattern. The sampling plate patterning is typically visible in the variable hologram image exhibited by the security device which may be used to create a striking visual impact (such as the “tiger” example of the eighth example above), but may in fact create an unwanted artefact that detracts from the primary effect.

The inventors have found that the effects set out above can also be generated using a sampling plate that comprises an array of focussing elements such as microlenses or micromirrors. FIG. 26 illustrates a schematic arrangement of a setup using an array of focussing elements 251 as the sampling plate 250, positioned in front of an artwork plate 190 in a corresponding manner to the arrangement seen in FIGS. 2 and 3a to 3c. The artwork plate 190 and sampling plate 250 are separated by a distance d substantially equal to the focal length of the focussing elements (here microlenses).

For example, the phase interference effects described in the first, second and third examples above can be generated using the array of microlenses 251. The same artwork plates as described above may be used, and only selected image segments will be directed, by the microlenses, towards the viewer at a given viewing angle, thereby generating the dynamic effects upon tilting the device.

An array of focussing elements may also be used to generate moiré magnification effects. Here, the artwork plate will comprise an array of microimages that is mismatched with the array of focussing elements. Each microimage element is a complete, miniature version of the image which is ultimately observed on viewing the device, and the array of focussing elements acts to select and magnify a small portion of each underlying microimage element, which portions are combined by the human eye such that the whole, magnified image is visualised when viewing the device. The magnified array appears to move relative to the device upon tilting and can be configured to appear above or below the surface of the device.

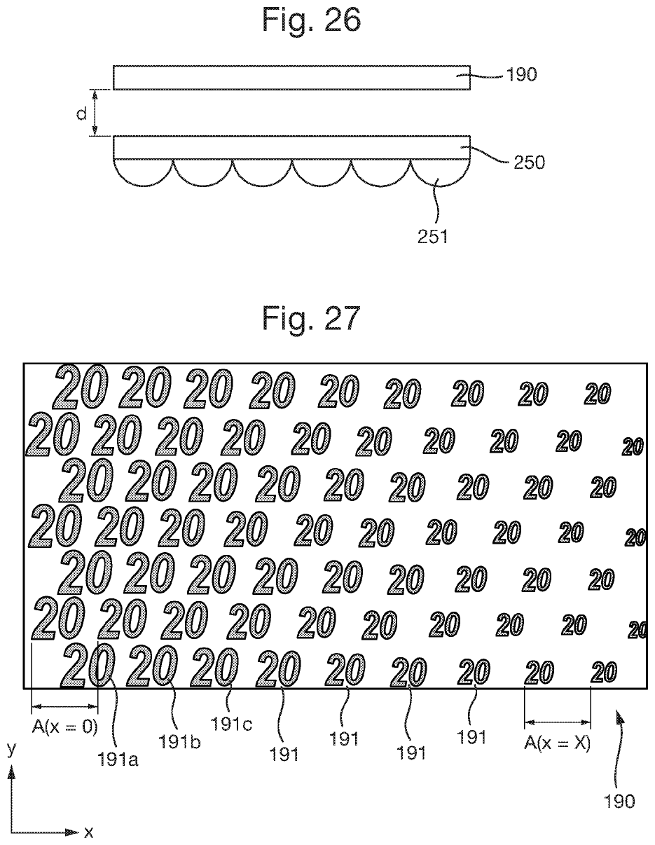

FIG. 27 is an example of an artwork plate 190 that may be used with a sampling plate comprising an array of microlenses 250. Here the artwork plate comprises an array of microimage elements 191, with each microimage element 191 taking the form of a “20”, and with each microimage element being typically tens or hundreds of times smaller in dimension that the “20”s that will be replayed in the final magnified image.

At the left-hand side of the plate 190, i.e x=0, the pitch A(x=0) between adjacent microimage elements 191 (in the x-direction) is selected to replay at a first image depth. At the right-most side of the plate, i.e. x=X, the pitch A(x=X) between adjacent microimage elements is selected to return a greater image depth. Between x=0 and x=X, the pitch A continuously varies. Preferably, the pitch changes between each adjacent pair of elements 191—for instance, the spacing between elements 191a and 191b is slightly less than that between elements 191b and 191c. In this way, the gradual change in image plane depth when viewing the device will be perceived as a smooth surface to the human eye. However, in some cases the same result can be achieved if two or more adjacent pairs of elements share the same spacing. Equations 1, 2 and 3 described above can be used to determine the pitch of the microimage elements and the pitch of the lens array required to obtain the desired depth effects (here the pitch variation is seen in the artwork plate but it will be appreciated that the pitch of the lens array may vary instead or in addition).

In this example, the pitch variation is only applied along the X axis but in other embodiments the pitch of the microimage element array could instead vary along the Y axis, which would result in a plane appearing to tilt towards the “top” or “bottom” edge of the device rather than the left/right edges. In still further embodiments, the pitch could vary along both the X and Y axes, in which case the image plane would appear to tilt in both directions.

It will be noted that, in FIG. 27, the size of the individual microimage elements 191 also changes from the left to the right of the array plate 190. This is not essential. If all of the microimage elements are formed at the same size, there will be distortion of the magnified image. In some implementations this can be made use of as a visual effect in itself. However, in the present example, it is desired to remove size distortion so that the magnified elements appear to have substantially the same size as each other.

The use of an array of focussing elements as the sampling plate also allows integral imaging effects to be recorded in the holographic image layer of the device. Here, the artwork plate 190 comprises an array of microimages, with each microimage being a miniature version of the final image to be exhibited. However, unlike with moiré magnification, there is no mismatch between the focussing elements and the microimages, and instead the visual effect is created by arranging for each microimage to be a view of the same object but from a different viewpoint. When the device is tilted, different ones of the images are magnified by the lenses such that the impression of a three dimensional image is given to a viewer.

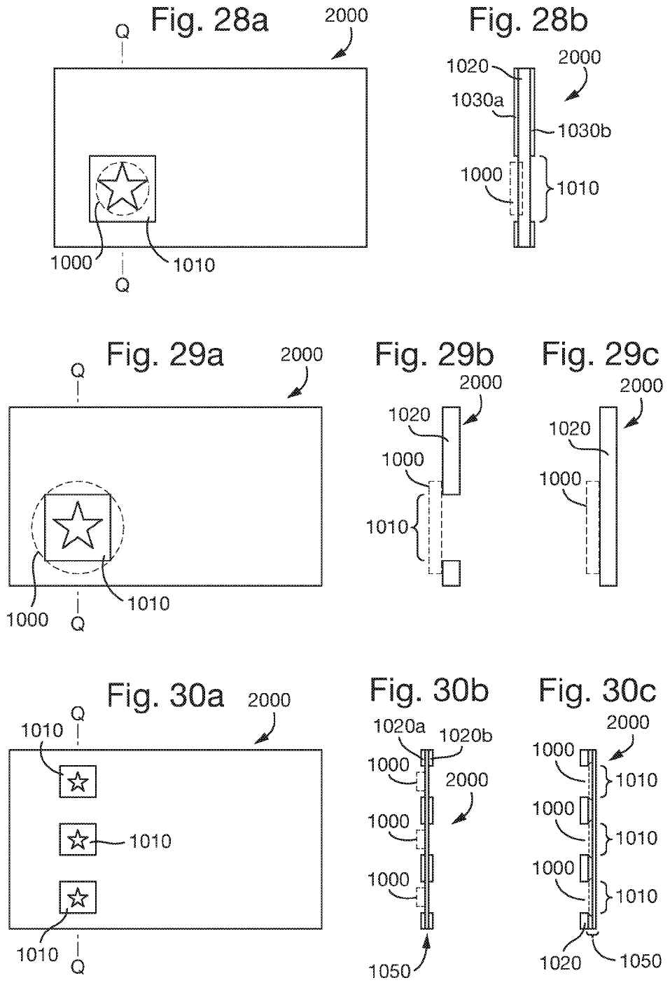

The security device of the present invention may be designed to be viewed in reflection or transmission. FIGS. 28, 29 and 30 depict examples of security documents in which security devices of the sorts described above have been incorporated. FIG. 28 shows a first exemplary security document, here a banknote 2000, in (a) plan view and (b) cross-section along line Q-Q′. Here, the banknote 2000 is a polymer banknote, comprising an internal transparent polymer substrate 1020 which is coated on each side with opacifying layers 1030a and 1030b in a conventional manner. In some cases, the opacifying layers may be provided on one side of the substrate 1020 only. The opacifying layers 1030a and 1030b are omitted in a region of the document so as to define a window 1010, here having a square shape. Within the window region 1010 is located a security device 1000 in accordance with any of the examples discussed above. The security device 1000 may be formed by cast-curing a suitable carrier material onto the substrate 1020, in which the desired relief structure is formed. Alternatively, the security device 1000 may have been formed separately on a security article such as a transfer patch or label. In this case, the security device 1000 may be affixed to the transparent substrate 1020 inside the window region 1010 by means of a suitable adhesive. Application may be achieved by a hot or cold transfer method e.g. hot stamping.

It should be noted that a similar construction could be achieved using a paper/plastic composite banknote in which the opacifying layers 1030a and 1030b are replaced by paper layers laminated (with or without adhesive) to an internal transparent polymer layer 1020. The paper layers may be omitted from the window region from the outset, or the paper could be removed locally after lamination. In other constructions, the order of the layers may be reversed with a (windowed) paper layer on the inside and transparent polymer layers on the outside.

FIG. 28 shows the use of a “full” window where the regions where the opacifying layers are omitted are in register. It will be appreciated that the device 1000 may be applied in a “half window”, for example in a case where opacifying layer 1030b was present across window region 1010.

In FIG. 29, the banknote 2000 is of conventional construction having a substrate 1020 formed for example of paper or other relatively opaque or translucent material. The window region 1010 is formed as an aperture through the substrate 1020. The security device 1000 is applied as a patch overlapping the edges of window 1010 utilising an adhesive to join the security article to the document substrate 1020. Again, the application of the security device and document could be achieved using various methods including hot stamping. FIG. 29(b) shows a variant in which the window 1010 is omitted and the device 1000 is simply applied to a section of the substrate 1020 using any convenient application technique such as hot stamping. In such arrangements the device 1000 will of course only be viewable from one side of the security document 2000.

FIG. 30 depicts a third example of a security document, again a banknote 2000, to which a security article 1050 in the form of a security thread or security strip has been applied. Three security devices 1000 each carried on the strip 1050 are revealed through windows 1010, arranged in a line on the document 2000. Two alternative constructions of the document are shown in cross-section in FIGS. 30(b) and 30(c). FIG. 30(b) depicts the security thread or strip 1050 incorporated within the security document 2000, between two portions of the document substrate 1020a, 1020b. For example, the security thread or strip 1050 may be incorporated within the substrate's structure during the paper making process using well known techniques. To form the windows 1010, the paper may be removed locally after completion of the paper making process, e.g. by abrasion. Alternatively, the paper making process could be designed so as to omit paper in the desired window regions. FIG. 30(c) shows an alternative arrangement in which the security thread or strip 1050 carrying the security device 1000 is applied to one side of document substrate 1020, e.g. using adhesive. The windows 1010 are formed by the provision of apertures in the substrate 1020, which may exist prior to the application of strip 1050 or be formed afterwards, again for example by abrasion.

Many alternative techniques for incorporating security devices of the sorts discussed above are known and could be used. For example, the above described device structures could be formed on other types of security document including identification cards, driving licenses, bankcards and other laminate structures, in which case the security device may be incorporated directly within the multilayer structure of the document.

1-51. (canceled)

52. A method of manufacturing a holographic image layer for a security device, comprising:
providing a holographic recording medium;
providing first and second overlapping patterns of elements, and;
holographically recording, in the holographic recording medium, the optically variable effect generated by illuminating the first and second overlapping patterns of elements, wherein;
the first pattern of elements comprises a first set of image elements and at least a second set of image elements, and;
the pitches and relative locations of the first and second patterns of elements are such that, upon illumination of the holographic image layer, at a first viewing position of the holographic image layer the first set of image elements are exhibited and at a second, different viewing position of the holographic image layer the second set of image elements are exhibited.

53. The method of claim 52, wherein at least one of the first and second patterns of elements, or both in combination, define indicia.

54. A method of manufacturing a holographic image layer for a security device, comprising:
providing a holographic recording medium;
providing first and second overlapping patterns of elements, and;
holographically recording, in the holographic recording medium, the optically variable effect generated by illuminating the first and second overlapping patterns of elements, wherein;
the pitches and/or relative rotations of the first and second patterns of elements and their relative locations are such that, upon illumination of the holographic image layer, the holographic image layer exhibits a magnified version of at least a part of the first pattern of elements due to the moiré effect, and further wherein;
at least one of the first and second patterns of elements comprises a first area having a first pitch along at least one axis and a second area having a second, different pitch along said axis, whereby the moiré effect causes different degrees of magnification of the first pattern of elements to occur, such that the holographic image layer exhibits areas of different depth corresponding to the first and second areas.

55. A method of manufacturing a holographic image layer for a security device, comprising:
providing a holographic recording medium;
providing first and second overlapping patterns of elements, and;
holographically recording, in the holographic recording medium, the optically variable effect generated by illuminating the first and second overlapping patterns of elements, wherein;
the pitches and/or relative rotations of the first and second patterns of elements and their relative locations are such that, upon illumination of the holographic image layer, the holographic image layer exhibits a magnified version of at least a part of the first pattern of elements due to the moiré effect, and further wherein;
the holographic image layer comprises a volume hologram.

56. The method of claim 54, wherein the first pattern of elements comprises an array of image elements that are compressed along at least the axis along which magnification occurs due to the moiré effect.

57. The method of claim 52, wherein at least one of the first and second patterns of elements comprises a one dimensional line screen pattern or a one dimensional pattern of indicia.

58. The method of claim 52, wherein at least one of the first and second patterns of elements comprises a two dimensional line screen pattern or dot screen pattern, or a two dimensional pattern of indicia.

59. The method of claim 52, wherein the second pattern of elements comprises a one dimensional or two dimensional array of focussing elements.

60. The method of claim 59, wherein the first and second patterns of elements are spaced apart by a distance substantially equal to the focal length of the focussing elements.

61. The method of claim 52, wherein the holographic image layer comprises an embossed hologram.

62. The method of claim 52, wherein the holographic image layer comprises a volume hologram.

63. The method of claim 55, wherein the first pattern of elements comprises an array of image elements that are compressed along at least the axis along which magnification occurs due to the moiré effect.

64. The method of claim 54, wherein at least one of the first and second patterns of elements comprises a one dimensional line screen pattern or a one dimensional pattern of indicia.

65. The method of claim 55, wherein at least one of the first and second patterns of elements comprises a one dimensional line screen pattern or a one dimensional pattern of indicia.

66. The method of claim 54, wherein at least one of the first and second patterns of elements comprises a two dimensional line screen pattern or dot screen pattern, or a two dimensional pattern of indicia.

67. The method of claim 55, wherein at least one of the first and second patterns of elements comprises a two dimensional line screen pattern or dot screen pattern, or a two dimensional pattern of indicia.

68. The method of claim 54, wherein the second pattern of elements comprises a one dimensional or two dimensional array of focussing elements.

69. The method of claim 55, wherein the second pattern of elements comprises a one dimensional or two dimensional array of focussing elements.

70. The method of claim 54, wherein the holographic image layer comprises an embossed hologram.

71. The method of claim 54, wherein the holographic image layer comprises a volume hologram.
